(19) United States
(12) Patent Application Publication
(10) Pub. No.: US 2026/0153587 A1
(43) Pub. Date: Jun. 4, 2026

(54) ENHANCED ASSET TRACKING SYSTEMS AND METHODS FOR ELECTRONIC SHELF LABEL SYSTEMS

(71) Applicant: QUALCOMM Incorporated, San Diego, CA (US)

(72) Inventors: Varun Amar Reddy, San Diego, CA (US); Sony Akkarakaran, Poway, CA (US)

(21) Appl. No.: 18/968,826

(22) Filed: Dec. 4, 2024

(51) Int. Cl. G01S 1/20; H04B 17/318

(52) U.S. Cl. CPC G01S 1/20; H04B 17/328

(57) ABSTRACT

This disclosure provides systems, methods, and devices for Electronic Shelf Label (ESL) systems that support enhanced notification coexistence techniques. In a first aspect, a device includes a processor and a memory. The processor is configured to cause the device to receive a plurality of electronic tag (eTag) beacons at one or more wireless radios of a stocking device and to generate eTag measurement information based on the measurement of the plurality of eTag beacons. The processor is further configured to cause the device to transmit the eTag measurement information to an electronic shelf label (ESL) server, and the eTag measurement information is indicative of whether a particular eTag has been removed from the stocking device. Other aspects and features are also claimed and described.

### TECHNICAL FIELD

Aspects of the present disclosure relate generally to wireless communication systems, and more particularly, to electronic shelf label (ESL) systems. Some features may enable and provide improved asset tracking for ESL systems, including automated asset stocking operations for ESL systems.

### INTRODUCTION

In general, retail stores use paper labels to display information about products displayed on shelves, such as prices, discount rates, unit costs, origins, or the like. Using such paper labels for the price display has limitations. For example, when there are changes in product information or locations on shelves, the retailer must generate new paper labels and discard old ones. This raises costs for maintenance in both supplies and employee labor. Further, in environmental terms, replacing the labels wastes raw materials such as paper, which adversely affects the protection of the environment. Still further, humans are prone to make mistakes, such as mislabeling a shelf or product or forgetting to take down temporary price changes on certain shelving, which results in shopper frustration.

Electronic shelf label (ESL) devices are electronic devices for displaying price information for items on retail store shelves, which may be used in place of paper labels. ESL devices may be attached to a front edge of retail shelving and display a variety of pricing information using display devices, such as Liquid Crystal Displays (LCD). Whenever the information about a product or the location of a product is changed, the ESL device may be programmed with new product information. Thus, the electronic shelf label can be repeatedly used.

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Electronic shelf label (ESL) devices may be used in a wireless network to provide information and services to shoppers and retailers (as users of an ESL system). For example, ESL devices operating on a wireless network as part of ESL system may support position location services to identify the location of ESLs devices and/or assets within an environment (e.g., a retail store or warehouse). As another example, the ESL system may support position location services to identify a position of users within the environment by interacting with the user's mobile device. Such position/location services and information can be used to facilitate notification and/or navigation requests. Example embodiments provide for enhanced asset tracking operations which enable automated asset stocking operations, including automated status and location determinations for use in position location services. The enhancements may utilize a stocking device to enable automated updating of status and locations for assets during stocking.

In one aspect of the disclosure, a device for wireless communication includes at least one processor and a memory coupled to the at least one processor. The at least one processor is configured to cause the device to: receive a plurality of electronic tag (eTag) beacons at one or more wireless radios of a stocking device; generate eTag measurement information based on the measurement of the plurality of eTag beacons; and transmit the eTag measurement information to an electronic shelf label (ESL) server, wherein the eTag measurement information is indicative of whether a particular eTag has been removed from the stocking device.

In an additional aspect of the disclosure, a method for wireless communication includes receiving a plurality of electronic tag (eTag) beacons at one or more wireless radios of a stocking device; generating eTag measurement information based on measuring the plurality of eTag beacons; and transmitting the eTag measurement information to an electronic shelf label (ESL) server, wherein the eTag measurement information is indicative of whether a particular eTag has been removed from the stocking device.

In an additional aspect of the disclosure, a device for wireless communication includes at least one processor and a memory coupled to the at least one processor. The at least one processor is configured to cause the device to: receive a plurality of electronic tag (eTag) beacons at one or more wireless radios of a stocking device; generate eTag measurement information based on measurements of the plurality of eTag beacons; determine whether a particular eTag has been removed from the stocking device based on the eTag measurement information; and transmit eTag indication information to an electronic shelf label (ESL) server responsive to a determination that the particular eTag has been removed from the stocking device, wherein the eTag indication information indicates that the particular eTag has been removed from the stocking device.

In an additional aspect of the disclosure, a device for wireless communication includes at least one processor and a memory coupled to the at least one processor. The at least one processor is configured to cause the device to: receive a plurality of electronic tag (eTag) beacons at one or more wireless radios of a stocking device; generate eTag measurement information based on measurements of the plurality of eTag beacons; generate eTag position information based on the eTag measurement information; and transmit the eTag position information to an electronic shelf label (ESL) server, wherein the eTag position information is indicative of whether a particular eTag has been removed from the stocking device.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

Devices, networks, and systems may be configured to communicate via one or more portions of the electromagnetic spectrum. The present disclosure describes certain aspects with reference to certain communications technologies, such as Bluetooth or Wi-Fi. However, the description is not intended to be limited to a specific technology or application, and one or more aspects described with reference to one technology may be understood to be applicable to another technology. Moreover, it should be understood that, in operation, wireless communication networks adapted according to the concepts herein may operate with any combination of licensed or unlicensed spectrum depending on loading and availability. Accordingly, it will be apparent to a person having ordinary skill in the art that the systems, apparatus, and methods described herein may be applied to other communications systems and applications than the particular examples provided.

For example, the described implementations may be implemented in any device, system, or network that is capable of transmitting and receiving RF signals according to any of the wireless communication standards, including any of the IEEE 802.11 standards, the IEEE 802.15.1 Bluetooth® standards, Bluetooth low energy (BLE), code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1×EV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, 5G New Radio (5G NR), 6G, or other known signals that are used to communicate within a wireless, cellular, or internet of things (IOT) network, such as a system utilizing 3G, 4G 5G, or 6G technology, or further implementations thereof.

In various implementations, the techniques and apparatus may be used in wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks, systems, or devices), as well as other communications networks. As described herein, the terms “networks” and “systems” may be used interchangeably and may refer to a collection of devices capable of communicating with each other through one or more communications techniques.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, or packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.).

Implementations may range from chip-level or modular components to non-modular, non-chip-level implementations and further to aggregated, distributed, or original equipment manufacturer (OEM) devices or systems incorporating one or more described aspects. In some settings, devices incorporating described aspects and features may also include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, or constitutions.

In the following description, numerous specific details are set forth, such as examples of specific components, circuits, and processes to provide a thorough understanding of the present disclosure. The term “coupled” as used herein means connected directly to or connected through one or more intervening components or circuits. Also, in the following description and for purposes of explanation, specific nomenclature is set forth to provide a thorough understanding of the present disclosure. However, it will be apparent to one skilled in the art that these specific details may not be required to practice the teachings disclosed herein. In other instances, well-known circuits and devices are shown in block diagram form to avoid obscuring teachings of the present disclosure.

Some portions of the detailed descriptions which follow are presented in terms of procedures, logic blocks, processing, and other symbolic representations of operations on data bits within a computer memory. In the present disclosure, a procedure, logic block, process, or the like, is conceived to be a self-consistent sequence of steps or instructions leading to a desired result. The steps are those requiring physical manipulations of physical quantities. Usually, although not necessarily, these quantities take the form of electrical or magnetic signals capable of being stored, transferred, combined, compared, and otherwise manipulated in a computer system.

In the figures, a single block may be described as performing a function or functions. The function or functions performed by that block may be performed in a single component or across multiple components, and/or may be performed using hardware, software, or a combination of hardware and software. To clearly illustrate this interchangeability of hardware and software, various illustrative components, blocks, modules, circuits, and steps are described below generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Also, the example devices may include components other than those shown, including well-known components such as a processor, memory, and the like.

Unless specifically stated otherwise as apparent from the following discussions, it is appreciated that throughout the present application, discussions utilizing the terms such as “accessing,” “receiving,” “sending,” “using,” “selecting,” “determining,” “normalizing,” “multiplying,” “averaging,” “monitoring,” “comparing,” “applying,” “updating,” “measuring,” “deriving,” “settling,” “generating” or the like, refer to the actions and processes of a computer system, or similar electronic computing device, that manipulates and transforms data represented as physical (electronic) quantities within the computer system's registers and memories into other data similarly represented as physical quantities within the computer system's registers, memories, or other such information storage, transmission, or display devices.

The terms “device” and “apparatus” are not limited to one or a specific number of physical objects (such as one smartphone, one camera controller, one processing system, and so on). As used herein, a device may be any electronic device with one or more parts that may implement at least some portions of the disclosure. While the below description and examples use the term “device” to describe various aspects of the disclosure, the term “device” is not limited to a specific configuration, type, or number of objects. As used herein, an apparatus may include a device or a portion of the device for performing the described operations.

As used herein, including in the claims, the term “or,” when used in a list of two or more items, means that any one of the listed items may be employed by itself, or any combination of two or more of the listed items may be employed. For example, if a device is described as containing components A, B, or C, the device may contain A alone; B alone; C alone; A and B in combination; A and C in combination; B and C in combination; or A, B, and C in combination.

Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof.

Also, as used herein, the term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

Also, as used herein, relative terms, unless otherwise specified, may be understood to be relative to a reference by a certain amount. For example, terms such as “higher” or “lower” or “more” or “less” may be understood as higher, lower, more, or less than a reference value by a threshold amount.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1A is a block diagram illustrating an example Electronic Shelf Label (ESL) system according to some embodiments of this disclosure.

FIG. 1B is a block diagram illustrating an example ESL display according to some embodiments of this disclosure.

FIG. 2A is a perspective view of a gondola with Electronic Shelf Label (ESL) devices according to some embodiments of the disclosure.

FIG. 2B is a top-down view of a retail environment with Electronic Shelf Label (ESL) devices accessible to a user according to some embodiments of the disclosure.

FIG. 3 is a timing diagram illustrating time division multiplexing for communicating with multiple Electronic Shelf Label (ESL) devices according to some embodiments of the disclosure.

FIG. 4 is a block diagram illustrating an example ESL device according to some embodiments of this disclosure.

FIG. 5 is a block diagram illustrating an example wireless communication system that supports enhanced asset tracking operations according to one or more aspects.

FIG. 6 is a timing diagram illustrating an example process that supports enhanced asset tracking operations according to one or more aspects.

FIG. 7 is a timing diagram illustrating an example process that supports enhanced asset tracking operations according to one or more aspects.

FIG. 8A is a block diagram illustrating an example stocking device that supports enhanced asset tracking operations according to one or more aspects.

FIG. 8B is a diagram illustrating an example cart that supports enhanced asset tracking operations according to one or more aspects.

FIG. 9 is a diagram illustrating an example of an ESL system that supports enhanced asset tracking operations according to one or more aspects.

FIG. 10 is a timing diagram illustrating an example process that supports enhanced asset tracking operations according to one or more aspects.

FIG. 11 is a flow diagram illustrating an example process that supports enhanced asset tracking operations according to one or more aspects.

FIG. 12 is a flow diagram illustrating another example process that supports enhanced asset tracking operations according to one or more aspects.

FIG. 13 is a block diagram of an example UE that supports enhanced asset tracking to one or more aspects.

FIG. 14 is a block diagram of an example ESL device that supports enhanced asset tracking operations according to one or more aspects.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support enhanced Electronic Shelf Label (ESL) position based notification operations, including enhanced asset tracking operations for updating status and position information for assets using eTags. The enhanced ESL asset tracking operations may leverage stocking device and ESL controller based determination of asset position within an ESL system. For example, ESL stocking devices (e.g., smart carts or automated guided vehicles (AGVs)) and/or ESL controllers can determine a position for electronic tags (eTags) based on ESL wireless transmissions from the eTags. The present disclosure supports enhanced asset tracking operations that enable the system to generate and/or modify asset status and location information automatically during stocking operations.

Particular implementations of the subject matter described in this disclosure may be implemented to realize one or more of the following potential advantages or benefits. In some aspects, the present disclosure provides techniques for the automated determination and updating of asset status and location. For example, the ESL system can generate and/or modify asset location and status during stocking, restocking, and periodically, automatically based on eTag beacons. Thus, the ESL system can greatly reduce stocking errors and manual labor required when stocking assets and loading initial status and position information into ESL systems.

In some aspects, the ESL system may utilize interference reduction techniques to reduce unwanted interference from eTag beacons. For example, the ESL system may utilize eTag beacon filtering criteria (e.g., location based activation and/or deactivation) and physical buttons or locks to prevent eTag beacon transmissions under certain circumstances or reduce eTag beacon transmission rates. Selective activation of eTag beacons and/or reduction of redundant eTag beacons or eTag beacons by eTags with certain status, may greatly reduce interference while not impacting performance.

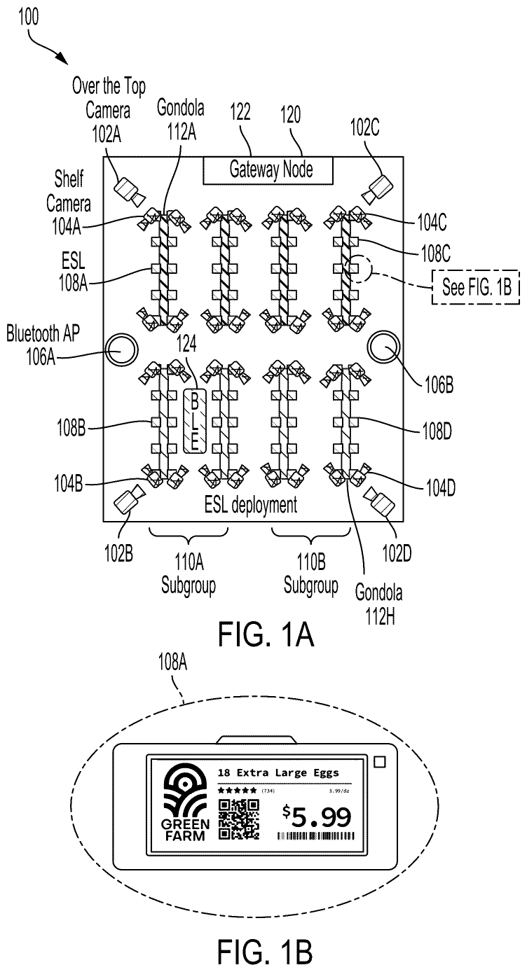

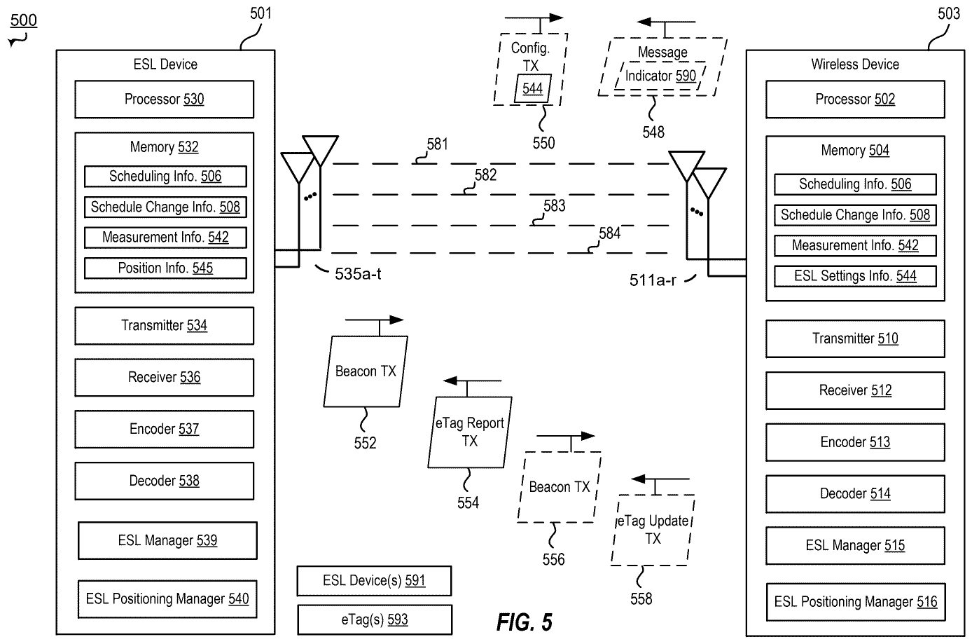

FIG. 1 is a block diagram illustrating an example Electronic Shelf Label (ESL) system according to some embodiments of this disclosure. An electronic shelf label (ESL) system 100 may include a management server 122 that is integrated with or coupled to a gateway node 120. The management server 122 may include at least one processor coupled to a memory, in which the at least one processor is configured to execute computer program code stored on a computer-readable medium to cause the management server 122 to perform operations related to managing operation of the ESL devices 108A-D, the APs 106A-106B, the gateway node 120, and/or other components within the ESL system 100. For example, the management server 122 may perform operations relating to ESL based position determination and/or generation of ESL notifications based on ESL based position determinations. For example, the management server 122 may perform operations described with reference to FIGS. 5-8.

The gateway node 120 may communicate with access point (AP) 106A and access point (AP) 106B. Although only two APs are shown in the example system, fewer or more APs may be included in the ESL system 100. The APs 106A and 106B may communicate through a first communication network, either wired or wireless, with the gateway node 120. The APs 106A and 106B also communicate through a second communication network with Electronic Shelf Label (ESL) tag devices. For example, the APs 106A and 106B may communicate with paired ESL devices in an assigned geographic area. In a first geographic assignment 110A, the AP 106A may communicate with ESL device 108A and ESL device 108B; in a second geographic assignment 110B, the AP 106B may communicate with ESL device 108C and ESL device 108D. The first and second communication networks may be different networks. In some embodiments, the first communication network for communication between AP 106A and gateway node 120 is a Wi-Fi network and the second communication network for communication between AP 106A and ESL device 108A is a Bluetooth network.

Bluetooth technology provides a secure way to connect and exchange information between electronic devices, such as smartphones, other cellular phones, headphones, earbuds, smartwatches, laptops, wearables, and/or shelf labels. Bluetooth communications may include establishing wireless personal area networks (PANs) (also referred to as “ad hoc” or “peer-to-peer” networks). These ad hoc networks are commonly called “piconets.” Each device may belong to multiple piconets. Multiple interconnected piconets may be called scatternets. A scatternet may be formed when a member of a first piconet elects to participate in a second piconet. In the example of FIG. 1, the ESL device 108A may be in a piconet with the AP 106A.

Because many of the services offered over Bluetooth can expose private data or allow the connecting party to control the connected device, Bluetooth networks may have devices first establish a “trust relationship” before they are allowed to communicate private data to one another. This trust relationship may be established using a process referred to as “pairing,” in which a bond is formed between two devices. This bond enables the devices to communicate with each other in the future without further authentication. The ESL device 108A may be bonded in such a manner to the AP 106A. The pairing process may be triggered automatically each time the device is powered on or moved within a certain distance of another Bluetooth device. Pairing information relating to current and previously established pairings may be stored in a paired device list (PDL) in the memory of the Bluetooth device, such as the ESL device 108A and/or the AP 106A. This pairing information may include a name field, an address field, a link key field, and other similar fields (such as “profile” type) useful for authenticating the device or establishing a Bluetooth communication link. The pairing information may allow the ESL device 108A to reconnect to the AP 106A automatically when, for example, power loss causes the ESL system 100 to reset.

A Bluetooth “profile” describes general behaviors through which Bluetooth-enabled devices communicate with other Bluetooth devices. For example, the hands free profile (HFP) describes how a Bluetooth device (such as a smartphone) may place and receive calls for another Bluetooth device, and the Advanced Audio Distribution Profile (A2DP) describes how stereo-quality audio may be streamed from a first Bluetooth device (such as a smartphone) to another Bluetooth device (such as an earbud). The ESL devices 108A-108D may be configured with an Electronic Shelf Label Profile compliant with the Electronic Shelf Label Profile v1.0 dated Mar. 28, 2023, which is incorporated by reference herein. The ESL Profile may specify how the AP 106A may use one or more ESL Services exposed by the ESL device 108A.

The management server 122 may be implemented as a database (DB) server that stores and manages product information regarding products displayed in a distribution store. The management server 122 may store a variety of information used during the operation of a store, as well as product information. Furthermore, the management server 122 may write and manage command messages that are used to carry out various functions such as the synchronization, updating, and alteration of product information displayed on the ESL devices 108A-108D. The management server 122 may be provided with a database for the ESL devices 108A-108D and product information displayed on the ESL devices 108A-108D. That is, the management server 122 may be provided with a database that stores identification information relating to ESL devices 108A-108D in connection with product information displayed on a corresponding one of the ESL devices 108A-108D.

A command message, created by the management server 122 (e.g., a product-information change message or a management-information acquisition message) can be transferred to the gateway node using a message packaged into a packet suitable for a communication scheme used with the gateway node 120, and transfer the configured packet. Furthermore, the management server 122 may receive a reception acknowledgement message, sent from the gateway node 120, through the communication scheme, convert the received message into a message receivable by the management server 122, and transfer the converted message. The messages may include notifications of an ESL system based on ESL determined positions as described further with reference to FIGS. 5-8.

Although only one gateway node 120 is shown in the ESL system 100, there may be several such gateway nodes communicating with the management server 122. Each gateway node 120 analyzes data received from the management server 122 confirming the presence or absence of a message or data, which is to be sent to the ESL device 108A, and then sends the confirmed message or data to the corresponding ESL device 108A. The gateway node 120 may configure a message, which is to be sent to the ESL device 108A, into a packet according to a communication scheme and send the configured packet to the ESL device 108A through commanding the AP 106A to transmit the packet. Furthermore, the gateway node 120 may transfer a reception acknowledgement message received from the ESL device 108A through the AP 106A to the management server 122.

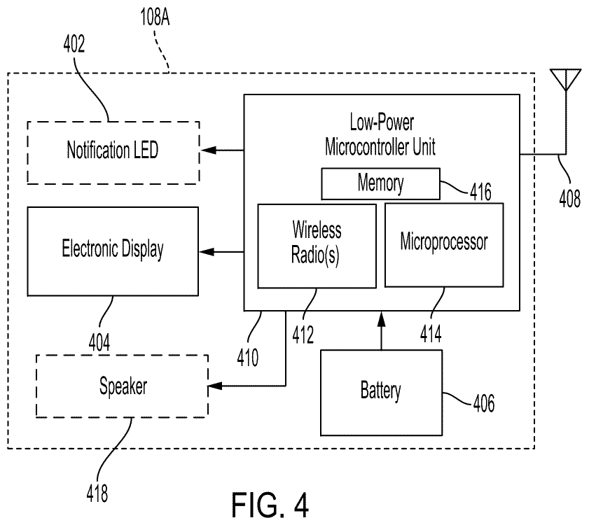

The ESL devices 108A-108D may include a plurality of ESL devices 108A-108D displaying data concerning product information received from the gateway node 120. The ESL devices 108A-D displaying product information associated with products may be attached to the shelving. One example layout of an ESL system 100 is shown across multiple gondolas 112A-112H. Each of the gondolas 112A-112H may include one or more shelves, to which the ESL devices 108A-108D are attached. The ESL device 108A-108D may be configured as shown, for example, in FIG. 4, with the microcontroller configured to perform operations described with reference to FIGS. 5-11.

In some embodiments, a video monitoring system may be included as part of ESL system 100 or used to augment the capabilities of the ESL system 100. For example, shelf cameras 104A-104D may be positioned with a field of view that captures one or more shelves of one or more of the gondolas 112A-112H. The shelf cameras 104A-104D may be used to assist in tracking stock levels and/or identifying items picked by users while in the environment. As another example, over-the-top (OTT) cameras 102A-102D may be positioned with a field of view capturing large regions of an environment of the ESL system 100. Object recognition systems may be applied to received image frames from the cameras 102A-D or 104A-D to determine a presence of, or count of, objects and humans in the field of view of a respective camera.

The OTT cameras 102A-102D may be used to support determination of a position of an ESL device 108A-D, user mobile device, or other devices within the environment. A mobile device supporting Bluetooth Low Energy (BLE), such as BLE device 124, may traverse the environment and communicate with the ESL devices 108A-108D, for example to receive identification information from the ESL devices 108A-108D, with the location of the ESL devices 108A-D determined by identifying a location of the BLE device 124 from the camera image frames at the time the BLE device 124 receives signals, and/or the strength of the signals, received from the ESL devices 108A-108D.

The ESL devices 108A-108D may change price information or be activated or inactivated while communicating with the gateway node 120. A store manager may send the management server 122 a command concerning the synchronization between a product and the ESL device 108A and/or a command for the correction of information regarding a product assigned to the ESL device 108A. An example ESL device display is shown inset in the FIG. 1, with such a device displaying information including a product description, a product image, a product price, a product barcode, a product rating, a product Stock Keeping Unit (SKU), and/or a product link (e.g., a URL or QR code).

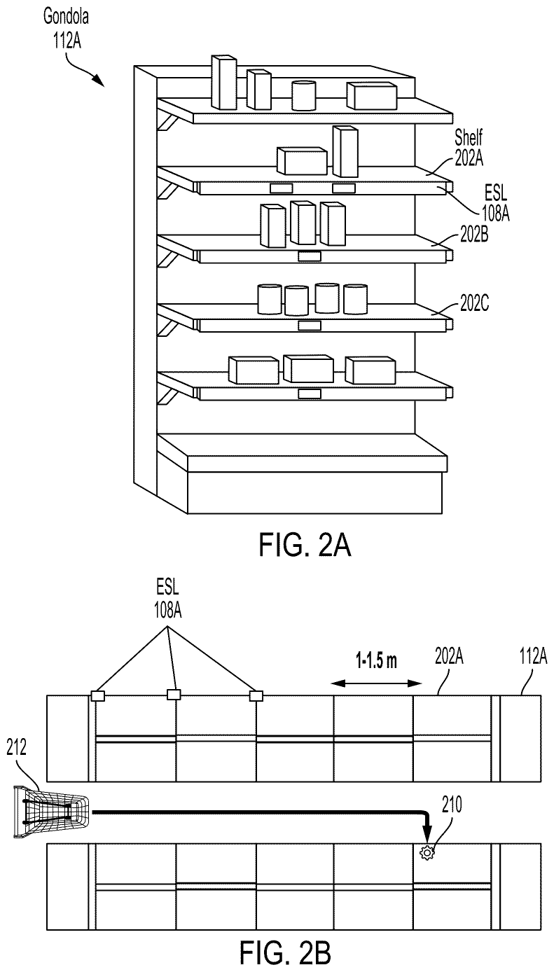

As described earlier, the environment may include ESL devices organized on gondolas and shelves. One example illustration of such an arrangement is shown in FIG. 2A. FIG. 2A is a perspective view of a gondola with Electronic Shelf Label (ESL) devices according to some embodiments of the disclosure. The gondola 112A may include multiple shelves 202A-202C at different vertical levels from a floor. ESL devices may be attached to the shelves 202A-202C. For example, ESL device 108A may be attached to shelf 202A to display information regarding products stocked on shelf 202A in the vicinity of the ESL device 108A.

The ESL devices may provide information to a shopper or store employee operating in the environment, such as to provide information regarding products and/or assist with location determination of products or the user. FIG. 2B is a top-down view of a retail environment with Electronic Shelf Label (ESL) devices accessible to a user according to some embodiments of the disclosure. A user pushing a shopping cart 212 through an aisle may use ESL devices to determine the location of a particular product. For example, a mobile device associated with the shopping cart 212 may guide a user to location 210 where stock for a desired product is located.

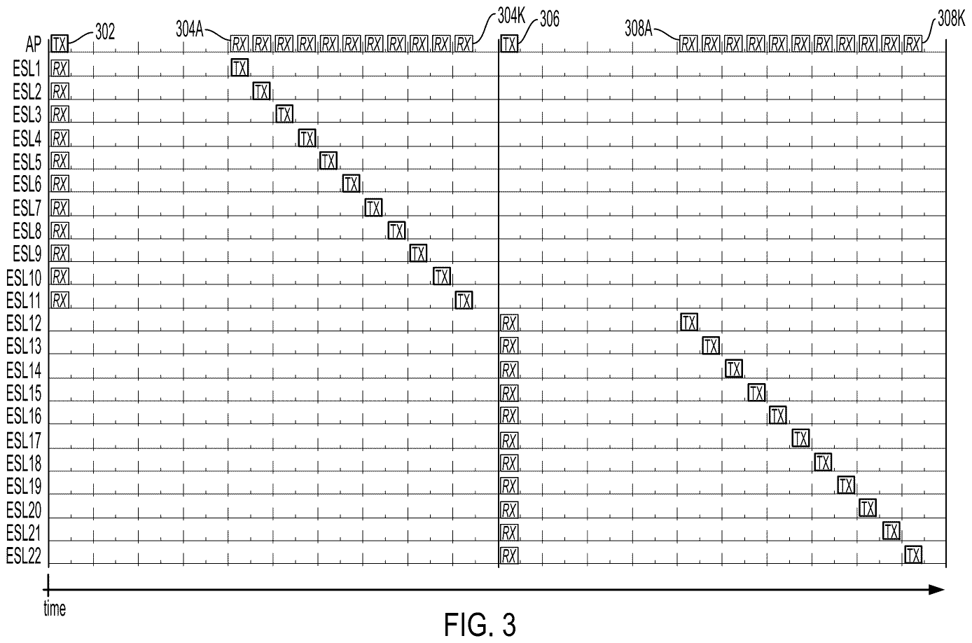

Communication within the ESL system 100 between an access point (AP) and Electronic Shelf Label (ESL) devices may be performed according to a Time Division Multiple Access (TDMA) scheme, such as one illustrated in FIG. 3. FIG. 3 is a timing diagram illustrating time division multiplexing for communicating with multiple Electronic Shelf Label (ESL) devices according to some embodiments of the disclosure. An AP, such as AP 106A, may broadcast information that is received by all ESL devices, including ESL device 108A, during a first time period 302. The ESL devices may communicate with the AP during subsequent time periods. For example, a first ESL device, such as ESL device 108A, may transmit in time period 304A, with other ESL devices transmitting in time periods 304B-304K. In ESL systems with significant numbers of ESL devices, the ESL devices may be configured to communicate in different groups. For example, ESL devices 1-11 may be configured to transmit to the AP during a first time cycle and ESL devices 12-22 may be configured to transmit to the AP during a second time cycle. The first and second time cycles may alternate during operation of the wireless network.

An ESL device may include components configured together to provide some or all of the functionality described in this disclosure and/or provide additional functionality. FIG. 4 is a block diagram illustrating an example Electronic Shelf Label (ESL) device according to some embodiments of this disclosure. The ESL device 108A may include a low-power microcontroller 410. Although functionality for the ESL device may be configured by the microcontroller 410 in embodiments of this disclosure, any single or combination of processors (e.g., at least one processor) may be used to perform the functions described according to embodiments of this disclosure.

The microcontroller 410 may include a memory 416. The memory 416 may store computer program code that causes a microcontroller 410 to execute operations that carry out some or all of the functionality described in embodiments of this disclosure. Although shown as part of the microcontroller 410, the memory 416 may be located internal to or external to the microcontroller 410. The microcontroller 410 may also include one or more wireless radio(s) 412. The wireless radios 412 may include, for example, a Bluetooth wireless radio including a front end that couples to antenna 408 for transmitting and receiving radio frequency (RF) signals at one or more frequencies in one or more frequency bands. In some embodiments, the microcontroller 410 is a System on Chip (SoC) in which two or more components of the wireless radio(s) 412, the microprocessor 414, and/or the memory 416 are included in a single semiconductor package. In some embodiments, the two or more components may be included on a single semiconductor die.

The ESL device 108A may include I/O devices, such as a notification LED 402 and/or an electronic display 404. The notification LED 402 may include one or more light emitting diodes (LEDs), or other light sources configured to flashlight of one or more colors. The notification LED may be triggered to blink at a specific time and/or with a specific color based on a command received from the gateway node 120. For example, a notification LED 402 may blink to attract a user's attention to a particular location on a shelf. The electronic display 404 may be, for example, an electronic-ink (e-Ink) display configured to output the product information. In some implementations, the ESL device 108A may include a speaker 418. The speaker 418 may include one or more audio output devices configured to output audio signals. For example, the speaker 418 may output tones, beeps, bell or chime sounds, or speech.

The ESL device 108A may couple to a battery 406 or other power source to power operations performed by the ESL device 108A, such as to operate the wireless radio(s) 412, the notification LED 402, the electronic display 404, the memory 416, the speaker 418, and/or the microprocessor 414. The battery 406 may allow placement of the ESL device 108A in a place where constant power supply is difficult. Thus, in order that a single battery charge provides a long period of use (e.g., lasting longer than several years), the ESL device 108 may be configured to reduce power consumption during times when frequent commands are not expected. For example, the ESL device 108A may operate using a wakeup communication scheme. That is, the ESL device 108A wakes up according to predetermined time intervals to determine whether data is waiting to be received. When no data is waiting, power to the ESL device 108A is turned off until the next wakeup period to reduce power consumption. When there is data to be received, the ESL device 108A wakes up to perform communication operations.

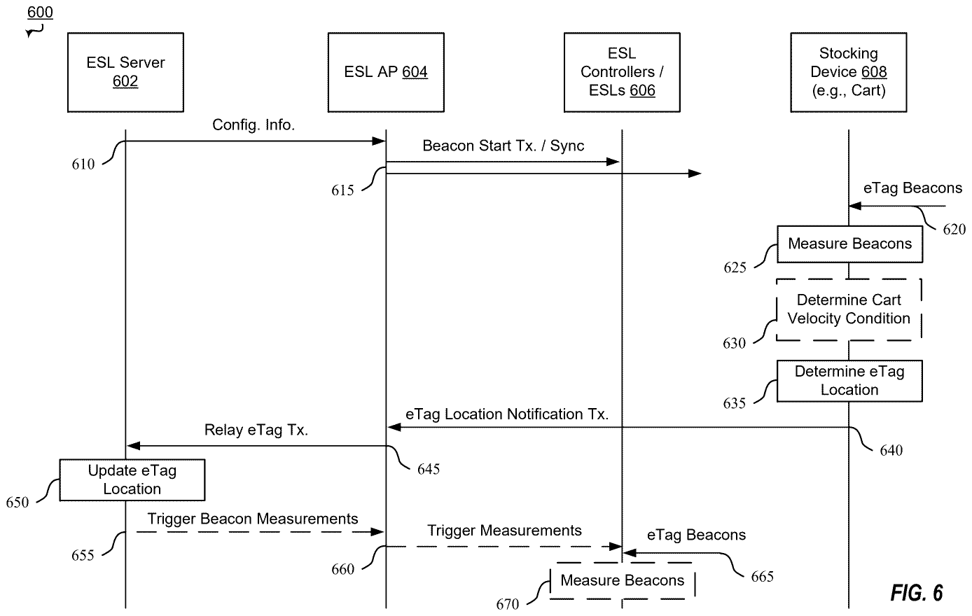

It is noted that one or more blocks (or operations) described with reference to FIGS. 1-4 may be combined with one or more blocks (or operations) described with reference to another of the figures. For example, one or more blocks (or operations) of FIG. 5 may be combined with one or more blocks (or operations) of FIGS. 1-4. As another example, one or more blocks associated with FIG. 6 may be combined with one or more blocks associated with FIGS. 1-4.

In certain scenarios, RSSI (Received Signal Strength Indicator) measurements can be obtained by a device to estimate its position. Some examples of such scenarios include position estimation for or by low-cost devices or anchor node infrastructure which cannot make perform time-of-arrival (ToA) or angle-of-arrival (AoA) measurements that require advanced processing capability. Electronic Shelf Label (ESL) infrastructure is one such example and presents a highly-dense network of anchor nodes that can achieve sub-meter accuracy in retail-store settings or warehouse/storage area settings, albeit with constraints on power consumption (since they are often battery-powered).

In such environments, a plurality of assets (e.g., products) may be stored throughout the ESL environment and tracked with a status and/or location. However, inputting all of these assets into the system and then tracking the changes to the assets over time is a time consuming and labor intensive task, and often involves many errors. Additionally, a plurality of users, such as workers, customers, and/or shippers, may interact with the assets and change a location and/or status of the assets and/or additional assets will need to be added (e.g., replenished or restocked) from time to time. Keeping track of the assets is a time intensive process and requests based on this information are often wrong as the system is often not accurate or update to date. Current ESL systems, and the constraints of the ESL themselves, may not be able to support automated asset tracking operations, such as for asset stocking and restocking.

In the aspects described herein, enhanced asset tracking systems and methods are disclosed for enabling the ESL system to utilize a smart stocking device to enable automated asset tracking operations. The enhanced asset tracking operations schemes may include utilizing a stocking device with a wireless radio or radios to measure eTag beacons and to relay the eTag beacon measurement information to the ESL server for asset status and/or location updating. The ESL server may additionally utilize ESL controller measurement of eTag beacons to confirm or refine the position or status indicated by the stocking device.

FIG. 5 illustrates an example of a wireless communications system 500 that supports enhanced ESL asset tracking operations in accordance with aspects of the present disclosure. In some examples, the wireless communications system 500 may implement aspects of ESL system 100. For example, the wireless communications system 500 may include an ESL network, such as ESL infrastructure including one or more ESL devices or network entities, and one or more wireless devices which interact with the ESL infrastructure. The wireless devices may include stocking devices, such as smart carts or trolleys with wireless device(s) and/or automated devices or robots. The wireless devices may also include UEs, such as cell phones or employee smart devices. As illustrated in the example of FIG. 5, the wireless communications system 500 includes an ESL device 501 and a wireless device 503.

The ESL device 501 may include or correspond to any of the ESL devices or infrastructure described herein, including the gateway node 120, the management server 122, an ESL AP (e.g., the AP 106A or 106B), an ESL device or controller (e.g., ESL devices 108C or 108D), or the ESL device 400 of FIG. 4. An ESL controller may include one or more ESL devices and a wireless radio and be referred to as an ESL rail controller.

The wireless device 503 may include or correspond to a stocking device or UE that interacts with ESL infrastructure, or to a second ESL device. The stocking device or UE may be part of the ESL infrastructure or separate from the ESL infrastructure. For example, the stocking device or UE may be associated with a worker or a robot, or with a customer/shopper. The second ESL device may include any of the ESL devices of ESL device 501 and may include or correspond to a different type of ESL device from the ESL device 501. As illustrative, non-limiting examples, the ESL device 501 may include or correspond to an ESL controller associated with one or more ESLs and the wireless device 503 may include or correspond to an ESL AP, an ESL server, or an IoT tag associated with a product or asset of the ESL network.

As illustrated in the example of FIG. 5, the wireless communications system 500 may further include one or more ESL devices 591 (e.g., second ESL devices), one or more eTags 593 (e.g., IoT tags or ESL tags). The one or more ESL devices 591 may include or correspond to an ESL device which is the same type as or a different type from a type of the ESL device 501, a type of the wireless device 503, or both. The eTags 593 may include or correspond to passive or battery-less radios which may output a signal or beacon based on received RF energy. The eTags 593 may be coupled to or associated with one or more products or assets of the ESL system. In a particular implementation, the one or more ESL devices 591 may include an energizer device configured to provide RF energy to the eTags 593 and/or trigger the eTags 593 to broadcast beacons for measurement.

In some aspects, one or more of the eTags 593 may include a physical button or locking mechanism that can be used to either trigger eTag beacon transmissions in an on-demand manner and/or that can prevent eTag transmissions until activation or unlock. For example, an eTag may include a mechanical switch which can be activated (e.g., pressed) to prompt an eTag beacon or activate sending an eTag beacon (e.g., charging and sending or just sending). As another example, the eTag may include a magnetic switch which can be deactivated or activated by use of a magnet or magnetic force change (e.g., removal of a magnet or placing of magnet). In some such aspects, the magnet may be attached to a carton or case of products such that the eTags are activated upon moving the magnet away from the switch and breaking a magnetic coupling caused by breaking a seal of the carton or case, opening the carton or case, removing products from the carton or case, etc.

Enhanced ESL notification coexistence operations for ESL position based notification operations may provide additional functionality for the ESL network and devices which interact with the ESL network. For example, enhanced ESL notification coexistence operations may enable the ESL system to improve notification bandwidth and clarity to more clearly provide more notifications in a particular area over a time period. Accordingly, ESL network and device performance can be increased.

ESL device 501 and wireless device 503 may be configured to communicate via one or more portions of the electromagnetic spectrum. For example, the ESL device 501, the wireless device 503, or both, may be configured to communicate via one or more portions of the electromagnetic spectrum associated with Bluetooth transmissions, Wi-Fi transmissions, or cellular transmissions (including sub-6 GHz and 6 GHz).

ESL device 501 and wireless device 503 may be configured to communicate via one or more channels or component carriers (CCs), such as representative first channel 581, second channel 582, third channel 583, and fourth channel 584. Although four channels are shown, this is for illustration only, more or fewer than four channels may be used. One or more channels may be used to communicate control channel transmissions, data channel transmissions, and/or sidelink channel transmissions.

Each channel or CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more channels or CCs may have or be assigned to a Cell ID, or a Bandwidth Part (BWP) ID. The Cell ID may include a unique cell ID for the channel or CC, a virtual Cell ID, or a particular Cell ID of a particular channel or CC of the plurality of channels or CCs. Additionally, or alternatively, one or more channels or CCs may have or be assigned to a HARQ ID. Each channel or CC may also have corresponding management functionalities, such as, beam management or BWP switching functionality. In some implementations, two or more channels or CCs are quasi co-located, such that the channels or CCs have the same beam and/or same symbol.

In some implementations, control information may be communicated via ESL device 501 and wireless device 503. For example, the control information may be communicated using Bluetooth transmissions, Wi-Fi transmission, MAC-CE transmissions, RRC transmissions, DCI (downlink control information) transmissions, UCI (uplink control information) transmissions, SCI (sidelink control information) transmissions, another transmission, or a combination thereof.

Wireless device 503 can include a variety of components (e.g., structural, hardware components) used for carrying out one or more functions described herein. For example, these components can include processor 502, memory 504, transmitter 510, receiver 512, encoder, 513, decoder 514, ESL manager 515, ESL positioning manager 516, and antennas 511a-r. Processor 502 may be configured to execute instructions stored at memory 504 to perform the operations described herein. In some implementations, processor 502 includes or corresponds to the microcontroller unit 410 and/or the microprocessor 414 of FIG. 4, and memory 504 includes or corresponds to the memory 416 of FIG. 4. Memory 504 may also be configured to store scheduling information 506, schedule change information 508, measurement information 542, ESL settings information 544, or a combination thereof, as further described herein.

The scheduling information 506 includes or corresponds to data associated with or corresponding to transmission timing information of the wireless communications system 500. For example, the scheduling information 506 may include data indicating or identifying transmission windows, such as UL and/or DL slots, transmit opportunities or both. The scheduling information 506 may optionally include grant information, such as transmission grants.

The schedule change information 508 includes or corresponds to data associated with or corresponding to a change in the transmission timing identified in the scheduling information 506. For example, the schedule change information 508 identify one or more UL slots for UL transmissions, one or more DL slots for power saving operations, or both. The schedule change information 508 may optionally include grant information, such as a modified transmission grant or a new transmission grant that correspond to a previous transmission resource associated with another device, such as an e-Tag.

The schedule change information 508 may be used to selectively activate or deactivate beacons in a particular area, such as to reduce interference for stocking operations and/or to increase beacon transmission and/or measurement shortly after stocking operations. The schedule change information 508 may include changes to a recurring schedule and/or dynamic grants for transmission of energizer signals, eTag beacons, eTag beacon measurement, or any combination thereof.

The measurement information 542 includes or corresponds to data associated with or corresponding to measurements of wireless signals of the wireless communications system 500. For example, the measurement information 542 may include measurement data or measurement values associated with transmissions (e.g., Bluetooth or Wi-Fi transmissions) of the wireless communications system 500 and may enable the generation of position/location information. The measurement information 542 may include signal strength or quality measurements, such as reference signal received power (RSRP), reference signal received quality (RSRQ), RSSI, etc. Additionally, or alternatively, the measurement information 542 may include one or more of directionality information, such as AoA, timing information, such as TOA or round-trip time (RTT), or beam information.

The ESL settings information 544 includes or corresponds to data associated with enhanced ESL position determination operations and/or enhanced ESL position based notification operations. The ESL settings information 544 may include one or more types of enhanced ESL position determination operation modes and/or enhanced ESL position based notification operation modes and/or thresholds or conditions for switching between such enhanced modes and/or configurations thereof. For example, the ESL settings information 544 may have data indicating different thresholds and/or conditions for different enhanced ESL position determination modes and/or enhanced ESL position based notification modes, or a combination thereof.

Additionally, or alternatively, the ESL settings information 544 includes asset information, ESL device information, gondola information, store information, ESL transmission timing information (e.g., beacon timing information), UL and/or DL position determination modes, associated UE information, or a combination thereof.

Transmitter 510 is configured to transmit data to one or more other devices, and receiver 512 is configured to receive data from one or more other devices. For example, transmitter 510 may transmit data, and receiver 512 may receive data, via a network, such as a wired network, a wireless network, or a combination thereof. For example, wireless device 503 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 510 and receiver 512 may be replaced with a transceiver. Additionally, or alternatively, transmitter 510 or receiver 512 may include or correspond to one or more components of ESL device 108A described with reference to FIG. 4.

Encoder 513 and decoder 514 may be configured to encode and decode data for transmission. ESL manager 515 may be configured to perform enhanced asset tracking operations. For example, the ESL manager 515 may be configured to manage one or more ESL related services, such as to generate ESL position based requests and process ESL notifications based on ESL based positions. The ESL manager 515 may be configured to generate ESL position based requests or request information based on measurement information, position information, time information, or a combination thereof.

ESL positioning manager 516 may be configured to perform ESL measurement and position determination operations. For example, the ESL positioning manager 516 may be configured to measure ESL transmissions (e.g., beacons) and determine measurement information based on ESL information and transmissions. As another example, the ESL positioning manager 516 may be configured to determine one or more positions of itself or other devices based on measurements of beacons and/or reference signal(s), the measurement information. Additionally, the ESL positioning manager 516 may be configured to determine position or location information of other ESL devices from ESL transmissions. The position information may be used to determine notification information, such as asset removed or stocked indications.

In some implementations, the ESL positioning manager 516 may include or correspond to an ESL measurement manager may be configured to perform ESL position measurement and management operations. For example, the ESL measurement manager may be configured to measure received reference signals or beacons (e.g., beacons and/or beacon responses) to determine wireless information, measurement information, or both. The measurement information, such as measurement information 542, may be used to determine position information, such as position information 545, and/or an indication that an asset/eTag has been removed. In some aspects, the measurement information 542 includes indication information indicating that an asset/eTag has been removed.

Although one wireless device (i.e., wireless device 503) is shown in the example of FIG. 5, in other implementations the network may include additional wireless devices which interact with the ESL infrastructure (e.g., ESL device 501). The other wireless device or devices may include one or more elements similar to wireless device 503. In some implementations, the wireless device 503 and the other wireless device or devices are different types of UEs. For example, either UE may be a higher quality or have different operating constraints. To illustrate, one of the UEs may have a larger form factor or be a current generation device, and thus have more advanced capabilities and/or reduced battery constraints, higher processing constraints, etc. As another example, one UE may be associated with a person and the other UE may be associated with a robot or autonomous device.

ESL device 501 includes processor 530, memory 532, transmitter 534, receiver 536, encoder 537, decoder 538, ESL manager 539, ESL positioning manager 540, and antennas 535a-t. Processor 530 may be configured to execute instructions stores at memory 532 to perform the operations described herein. In some implementations, processor 530 includes or corresponds to low-power microcontroller unit 410 and/or microprocessor 414, and memory 532 includes or corresponds to memory 416 of FIG. 4. Memory 532 may be configured to store scheduling information 506, schedule change information 508, measurement information 542, ESL settings information 544, position information 545, or a combination thereof, and optionally other information such as described with reference to the wireless device 503 and as further described herein.

The position information 545 includes or corresponds to data associated with or corresponding to a position of an ESL device, such as one of ESL devices 591 or eTags 593, a position of a non-ESL device, such as wireless device 503, or both. For example, the position information 545 may include data which indicates or identifies a position of a non-ESL device. To illustrate, the position information 545 may include positioning information which indicates a position of the device, i.e., position information, or positioning information which may be used to derive the position of the device, such as measurement information 542. The position information 545 may enable the generation of notifications (e.g., notification information, indications and/or instructions), such as notifications for asset location, asset inventory, asset directions, etc.

In some implementations, the position information 545 includes location information. The location information includes or corresponds to data associated with or corresponding to a location of an ESL device of the wireless communications system 500. For example, the location information may include data used for determining a location (e.g., measurement data), data indicating a location, data indicating formulas or methods for calculating a location, or a combination thereof. The location information may include or correspond to an initial or original position or location of ESL devices or ESL infrastructure of the wireless communications system 500. Additionally, or alternatively, the position information 545 includes or is derived from measurement information, such as measurement information 542.

Transmitter 534 is configured to transmit data to one or more other devices, and receiver 536 is configured to receive data from one or more other devices. For example, transmitter 534 may transmit data, and receiver 536 may receive data, via a network, such as a wired network, a wireless network, or a combination thereof. For example, UEs and/or ESL device 501 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 534 and receiver 536 may be replaced with a transceiver. Additionally, or alternatively, transmitter 534 or receiver 536 may include or correspond to one or more components of ESL device 108A described with reference to FIG. 4.

Encoder 537, and decoder 538 may include the same functionality as described with reference to encoder 513 and decoder 514, respectively. ESL manager 539 may be configured to perform enhanced ESL asset tracking and position-based operations, and may include similar functionality as to ESL manager 515. The ESL manager 539 may be configured to obtain initial ESL device position information indicating device positions of ESL devices, to transmit beacon start transmissions and/or beacon transmission, or a combination thereof. As another example, the ESL manager 539 may be configured to determine ESL based positions for ESL devices or ESL assets and non-ESL devices and/or determine ESL notifications based on ESL based positions.

In some implementations, the ESL manager 539 may be configured to generate notifications or notification information based on measurement information, position information, request information, time information, or a combination thereof. The ESL manager 539 may include an ESL notification manager configured to perform ESL notification determination and management operations. For example, the ESL notification manager may be configured to generate and/or transmit enhanced ESL notifications, such as ESL notifications based on ESL based or determined positions. The ESL notification manager may be configured to determine notifications for assets, determine when and how to send the determined notifications, determine whether to send the determined notifications, determine notification coexistence information for assets, or a combination thereof. Additionally, the ESL notification manager may be configured to generation instructions for causing other ESL devices and/or UEs to output notifications, such as visual or auditory outputs, to provide a notification, such as directions, to a user or a UE. In some implementations, the ESL notification manager may include a notification filter configured to filter the generation and/or transmission of notifications.

ESL positioning manager 540 may include similar functionality as described with reference to the ESL positioning manager 516. For example, the ESL positioning manager 540 may be configured to perform ESL position determination operations. To illustrate, the ESL positioning manager 540 may be configured to determine a position of a device (e.g., ESL or non-ESL device) or asset (e.g., eTag) based on ESL beacon transmission measurements (measurement information) from the device. The ESL positioning manager 540 may utilize the beacon triggering messages and/or schedule change information to determine when and how to perform position determination operations, such as UL and/or DL-based position determination operations.

The ESL manager 539 may also be configured to perform ESL position determination operations. For example, the ESL manager 539 (or an ESL positioning manager thereof) may be configured to determine a position of a device (e.g., non-ESL device) based on ESL beacon transmission measurements (measurement information) from the device. The ESL manager 539 may utilize the position information to determine if multiple notifications satisfy a notification proximity condition.

In some implementations, the ESL device 501 may include similar functionality as described with reference to the ESL manager 515, the ESL positioning manager 516, or both, of the wireless device 503. Additionally, or alternatively, the wireless device 503 may include similar functionality as described with reference to the ESL manager 539, the ESL positioning manager 540, or both, of the ESL device 501.

During operation of wireless communications system 500, the network (e.g., ESL device 501) may determine that wireless device 503 has enhanced ESL asset tracking capability. For example, wireless device 503 may transmit a message 548 that includes an ESL asset tracking based notification indicator 590 (e.g., an enhanced asset measurement and/or position indicator). Indicator 590 may indicate ESL asset measurement capability and/or position determination capability for one or more operational modes. In some implementations, an ESL network entity (e.g., the ESL device 501) sends control information to indicate to the wireless device 503 that enhanced ESL asset tracking operations and/or a particular type of enhanced ESL notification coexistence operation is to be used (e.g., measurement operations or measurement and position operations). For example, in some implementations, configuration transmission 550 is transmitted to the wireless device 503. The configuration transmission 550 may include or indicate to use enhanced ESL asset tracking operations or to adjust or implement a setting of a particular type of enhanced ESL asset tracking operation. For example, the configuration transmission 550 may include ESL settings information 544.

During operation, devices of wireless communications system 500 perform enhanced ESL asset tracking operations. For example, the ESL network and wireless devices may exchange transmissions via uplink, downlink, and/or sidelink communications over the communication links and engage in enhanced ESL notification coexistence operations, as illustrated in the example of FIG. 5. Enhanced ESL asset tracking operations enable improved ESL or non-ESL devices to track a status and/or position of assets associated with the ESL system using eTags. The enhanced ESL asset tracking operations also the ESL system to be updated automatically with the status and/or position of eTags (which are associated with assets) and enables the ESL system to perform additional operations for such assets, such as provide notifications and/or directions to the assets to users, customers, automated devices, etc.

In the example of FIG. 5, the ESL device 501 generates the scheduling information for transmission in a scheduling, timing, or configuration transmission, such as scheduling or configuration transmission 550. For example, the ESL device 501 may generate overall ESL timing related parameters and information for scheduling beacon transmissions, including for scheduling or performing eTag beacon-based position determination operations. To illustrate, the ESL device 501 may generate timing/scheduling information relative to beacon start transmissions and/or energizing transmissions, such that the receiving eTags can utilize this information along with received trigger transmissions to determine when to transmit eTag beacons. Additionally, or alternatively, the configuration information may include measurement configuration information, position determination configuration information, or both to configure the asset tracking operations. The configuration information and/or scheduling information may be transmitted in multiple ways. For example, the configuration information and/or scheduling information may be transmitted via a local wireless network or protocol (e.g., Wi-Fi or Bluetooth) to ESL devices and/or non-ESL devices, or may be transmitted via another network or protocol (e.g., cellular) to non-ESL devices. The configuration information and/or scheduling information may be part of or separate from the ESL settings information 544, and may configure or enable the devices to engage in enhanced asset tracking operations.

Devices of the ESL network, such as the eTags 593, periodically transmit beacons 552, such as described with reference to FIG. 3, and further with reference to FIGS. 6-9. The beacons 552 may be measured by ESL and non-ESL devices to determine measurement information that indicates a relative position from the measuring device to the eTag or a position within the ESL system.

The wireless device 503 receives the beacons 552 and measures the beacons 552. For example, the wireless device 503 monitors and receives beacon transmissions from multiple eTags 593, measures the beacon transmissions, and determines a RSSI for each of the beacon transmissions. The wireless device 503 may perform other measurements and determine other types of measurement information, such as signal quality, signal strength, directional, time, etc., and as described further with reference to FIGS. 6-9.

The wireless device 503 transmits an eTag report transmission 554 to the ESL device 501 based on the measured beacons 552. The eTag report transmission 554 includes information indicating a status and/or position of one or more eTags which sent the beacons, and the information sent is generated based on the measurement information from measuring the beacons 552 and optionally based on measurement history information from measuring past eTag beacons. As an illustrative, example, the history information may store measurement information for multiple seconds, such as 1, 2, 3, 5, 10, etc.

In some implementations, the wireless device 503 transmits the measurement information to the ESL device 501. For example, the wireless device 503 generates positioning information based on the measurement information or to include the measurement information 542. In some such implementations, the ESL device 501 determines position information 545 based on the received positioning information (e.g., measurement information 542 thereof or indicated thereby). For example, the wireless device 503 generates the position information 545 based on the positioning information (e.g., measurement information and indication of removal/stocking).

In other implementations, the wireless device 503 determines position information 545 based on the measurement information 542 and transmits the position information 545 to the ESL device 501. For example, the wireless device 503 generates the position information 545 based on the measurement information 542 or to include the measurement information 542. Generation of position information based on measurement information is described further with reference to FIGS. 6-9.

Additionally, or alternatively, the wireless device 503 determines status information based on the measurement information 542 and transmits the status information to the ESL device 501. For example, the wireless device 503 generates positioning information based on the status information or to include the status information which is indicative of a change of status of a particular eTag (e.g., the eTag being removed a stocking device).

The ESL device 501 may update a status and location of the eTags based on the received eTag report transmission 554. For example, the ESL device 501 may determine a position and/or status of the eTag(s) based on the received positioning information. As another example, the ESL device 501 may update a position and/or status of the eTag(s) based on the received measurement, position, and/or status information.

As yet another example, the ESL device 501 may confirm a position and/or status of the eTag(s) indicated by the received information based on additional ESL operations. To illustrate, the ESL device 501 may cause the eTags 593 or a subset of the eTags 593 to transmit second beacon transmissions 596, such as by generating and transmitting schedule change information 508 to one or more devices of the ESL system (e.g., ESL device 591). The wireless device 503 and/or the ESL devices 591 may measure the second beacon transmissions 596 and may generate an eTag update transmission 558 similar to the generation of the eTag report transmission 554 based on the schedule change information 508. The eTag update transmission 558 includes information indicating a status and/or position of one or more eTags which sent the beacons, and the information sent is generated based on the measurement information from measuring the second beacons 556 and optionally based on measurement history information from measuring past eTag beacons (e.g., beacons 552). The ESL device 501 may then confirm the status and/or position of one or more of the eTags on the eTag update transmission 558 from the wireless device 503 and/or one or more of the ESL devices 591.

In the aspects described herein, the ESL system may engage in enhanced asset tracking operations to enable the ESL system to automatically generate and update asset status and location information to reduce asset notification errors and reduce time-intensive stocking task. For example, the ESL system may automate and reduce errors done when stocking assets into an ESL system and for monitoring the assets for changes periodically over time. The ESL system may then respond to asset notification requests by customers or employees more timely and more accurately, and the overhead in operating an ESL system is greatly reduced.

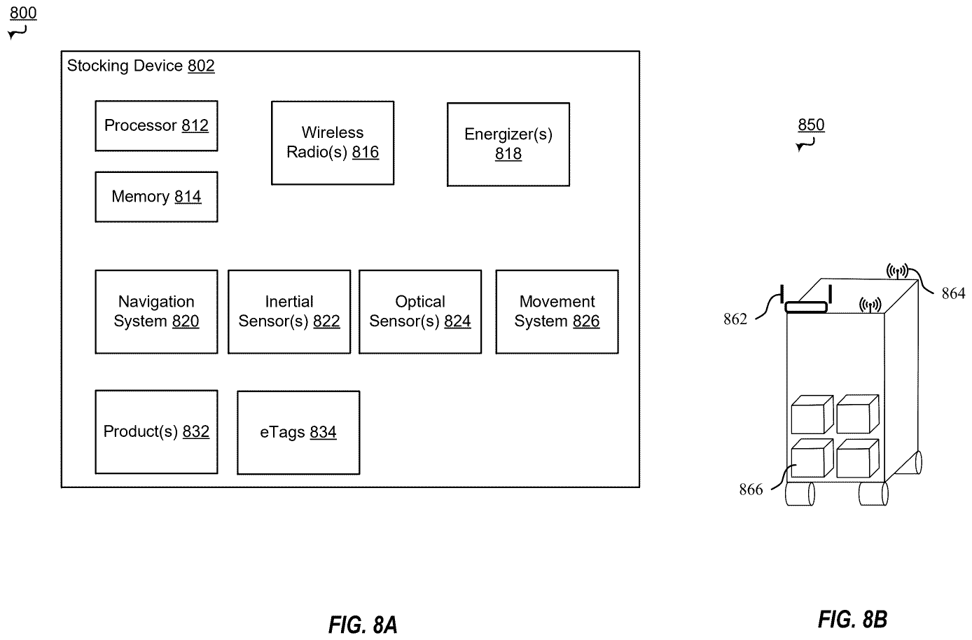

Additional examples of enhanced asset tracking operations, including descriptions and examples for different stocking devices, are described further with reference to FIGS. 6-9. For example, generation and transmission of asset information, and illustrative examples of enhanced asset tracking operations are described further with reference to FIGS. 6, 7, and 9 and different examples of stocking devices are described further with reference to FIGS. 8A and 8B.

Accordingly, the network (e.g., the ESL device 501 and the wireless device 503) may be able to perform enhanced asset tracking operations. Accordingly, the ESL network performance and ESL network and user experience may be increased due to enhanced ESL system capabilities of automated asset status and location generation and updating based on enhanced asset tracking capabilities. The automated status and location generation and updating may greatly reduce human error and increase the accuracy of ESL asset notifications, and may greatly reduce the intensive data entry workload and the time and errors associated with stocking assets in ESL systems.

Referring to FIG. 6, FIG. 6 is a timing diagram 600 illustrating an ESL system that supports enhanced asset tracking according to one or more aspects. The example of FIG. 6 corresponds to an example of enhanced asset tracking operations for a stocking device interacting with the ESL system where the stocking device determines a location of an asset and indicates the location to the ESL server, such as when an eTag is determined to be removed from the stocking device. The example FIG. 6 may enable improved ESL functionality for automated stocking operations or for automatically updating asset locations during stocking.

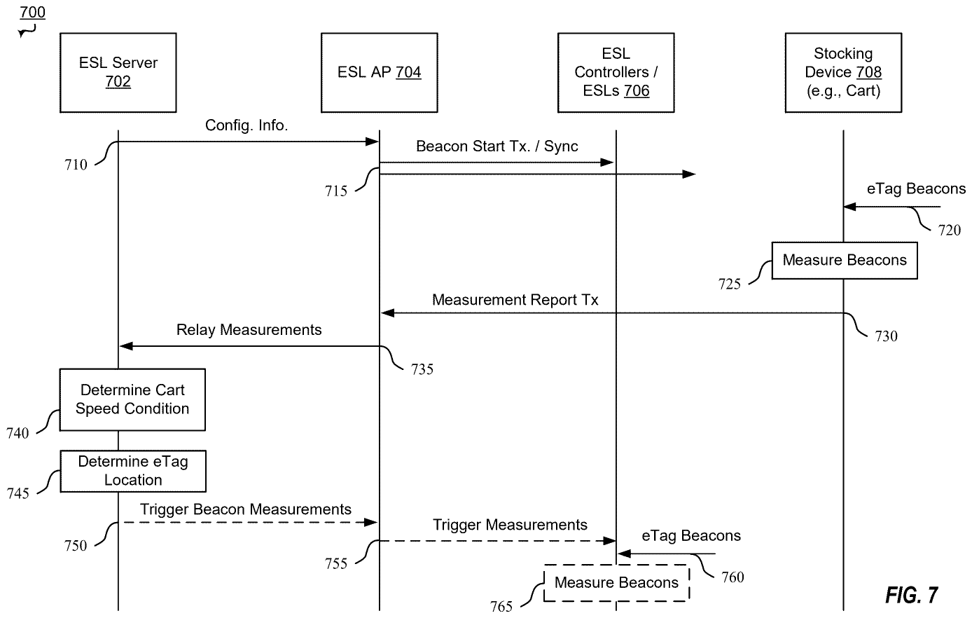

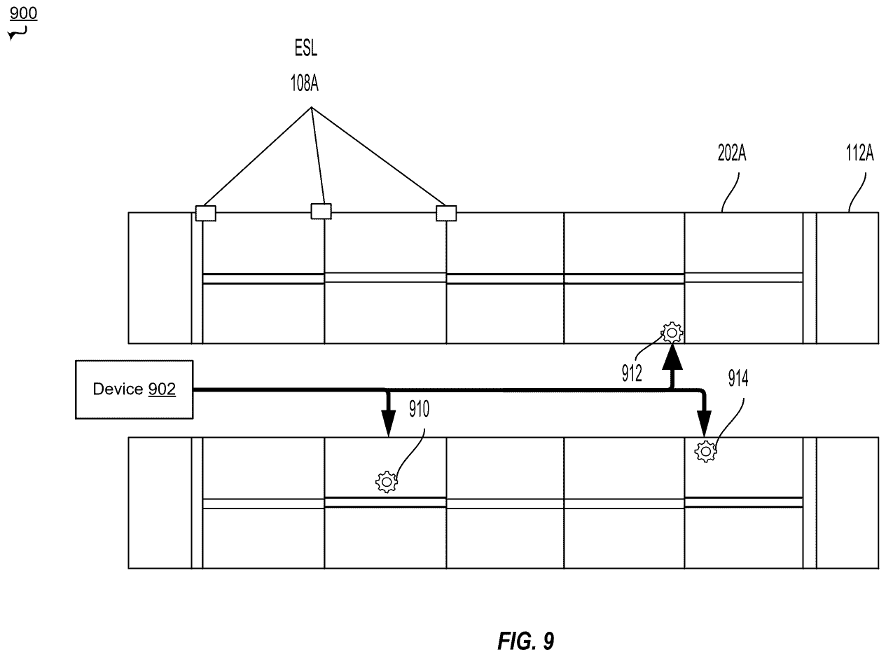

In the example of FIG. 6, the ESL system includes an ESL server 602, an ESL AP 604, ESL controllers 606, and a stocking device 608 (e.g., cart, trolley, AGV, etc.). Each of the ESL controllers 606 may include or correspond to an ESL with a wireless radio or a wireless device/radio associated with a plurality of ESLs. In the example of FIG. 6, the stocking device 608 may include one or more assets, such as cases or cartons of assets, and one or more cases/cartons or assets may include or be associated with an eTag or multiple eTags. Examples of stocking devices, such as the stocking device 608 or 708 of FIG. 7, are described further with reference to FIGS. 8A and 8B, and an example of operations of stocking devices are described further with reference to FIG. 9. The ESL system may optionally include or interact with one or more non-ESL devices, such as UEs.

Prior to 610, the ESL system may be configured with initial position information and/or configurations for network operation and positioning determination operations. For example, an operator may setup or preconfigure the system with initial positions for one or more devices and/or assets of the ESL systems. To illustrate, one or more of ESL APs, ESL controllers, ESLs, or assets (which may be tagged with an IoT tag or eTag) may be configured with an initial position. As another example, the ESL system may enter, such as upon initial setup, reconfiguration, or periodically (e.g., nightly weekly, monthly, quarterly, etc.), a measurement mode to determine initial or updated positions.

For example, the ESL server 602 may transmit configuration information (e.g., the configuration transmission 550 or the ESL settings information 544 of FIG. 5) to the ESL AP 604 and the ESL controllers 606. To illustrate, the ESL server 602 may transmit the configuration information directly to each device, such as by broadcast transmission or direct transmission, or the ESL server 602 may transmit the configuration information to ESL AP 604, which then transmits or relays then configuration information to one or more ESL devices, such as the ESL controllers 606. In an illustrative, non-limiting example, the ESL server 602 may transmit the configuration to ESL AP 604 via a wired connection, and the ESL AP 604 may unicast or broadcast the configuration information to the ESL devices and non-ESL devices.

As described above, the configuration information may include information configured to enable scheduling and timing coordination. For example, the configuration information may include UL and DL slot timing information for the difference devices or types/groups of devices.

Additionally, or alternatively, initial position information may be transmitted in the configuration information. For example, the operator may input a position into the ESL controllers 606, and the ESL controllers 606 may relay that position to the ESL server 602 via the ESL AP 604. As another example, the operator may configure the ESL server with the position of the ESL controllers 606, which is then relayed to the ESL controllers 606 via the ESL AP 604. As yet another example, each of the ESL controllers 606 determines its position based on a beacon of the ESL AP 604, and transmits its determined position to the ESL server 602.

At 610, the ESL server 602 may transmit stocking configuration information (asset tracking configuration information) to the ESL AP 604 for relay to other ESL devices, other non-ESL devices, or both. For example, the ESL server 602 may unicast or broadcast a transmission to one or more ESL APs, including the ESL AP 604, which indicates or includes asset tracking configuration information. The ESL AP 604 may utilize the asset tracking configuration information to determine stocking operations configurations or modes and/or how to relay stocking notifications and/or stocking configuration information.

After 610, the ESL AP 604 may transmit stocking configuration information to one or more ESL controllers/devices, including the ESL controllers 606. For example, the ESL AP 604 may relay the stocking configuration information or transmit ESL controller stocking configuration information and/or stocking device stocking configuration information based on the received stocking configuration information from the ESL server 602. The ESL AP 604 may transmit the asset tracking configuration information by unicast or broadcast a transmission to the one or more ESL controllers/devices. The one or more ESL controllers/devices, including the ESL controllers 606 may utilize the asset tracking configuration information to determine how to engage in asset tracking operations, such as how to measure beacons, which beacons to measure, what information to relay to the ESL server 602, and when, etc.

Additionally, or alternatively, the ESL server 602 may transmit stocking configuration information to the stocking devices for participation in the ESL system. For example, the ESL server 602 may unicast or broadcast a transmission to one or more ESL or external devices, including the stocking device 608 (e.g., smart cart or AGV), which indicates or includes ESL stocking configuration information via another, non-ESL connection (e.g., cellular). The stocking device 608 may utilize the ESL stocking configuration information to determine stocking operations configurations or modes.

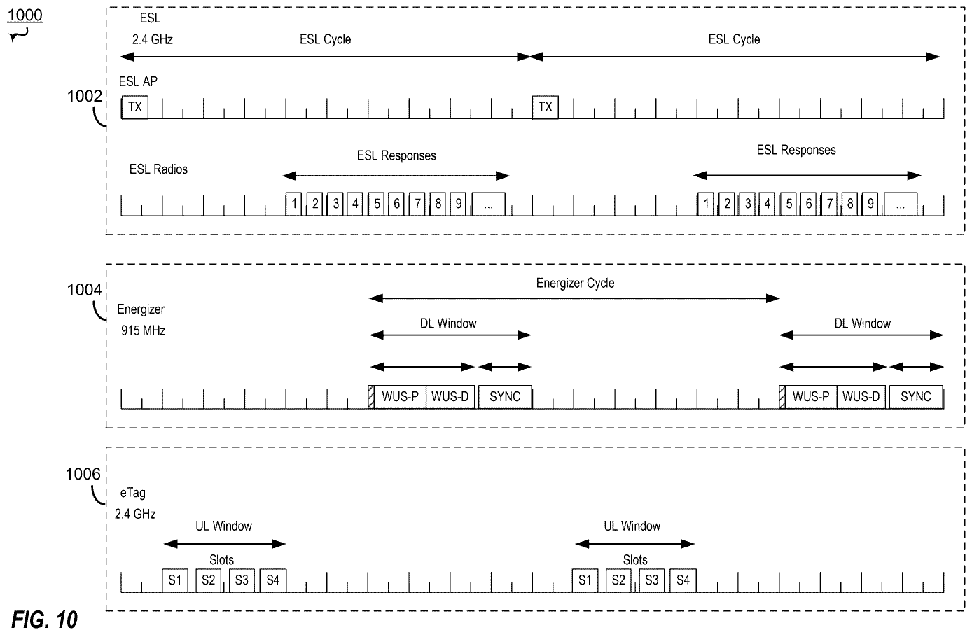

At 615, the ESL AP 604 may initiate beacon transmissions by ESL devices. For example, the ESL AP 604 may transmit a beacon start or synchronization transmission, such as the broadcast transmission at 302 of FIG. 3. The beacon start or synchronization transmission may be transmitted based on timing or scheduling information received from the ESL server 602, such as in the stocking configuration information received at 610, or based on prior received ESL configuration information. The beacon start or synchronization transmission may coordinate ESL cycles and timing windows, such as described with reference to FIG. 10.

To illustrate, the ESL AP 604 may broadcast a transmission which is configured to cause energizers, such as energizers of the ESL system or of the stocking device 608, to transmit energizing transmissions. As an illustrative example, a beacon synchronization or start transmission may initiate or coordinate other actions during an ESL cycle and may provide timing or synchronization information for energizers to transmit energizing signals which may be captured by other devices, such as eTags. Then, the eTags may utilize the captured energy to transmit an ESL beacon for measurement operations by ESL and/or non-ESL devices, at 620. The eTags may also determine timing information (e.g., scheduling information and/or timing synchronization information) for when to transmit the eTag beacons from the beacon start transmission from the ESL AP 604 and/or other beacon transmissions (e.g., DL beacon transmissions from the ESL controllers 606). The transmission broadcast by the ESL AP 604 may also be configured to cause the stocking device 608 to measure the eTag beacons sent at 620, such as by providing synchronization or timing information for slots during which the eTag beacons may be sent. In some aspects, the ESL system may engage in selective eTag beaconing to reduce interference, as further described with reference to FIGS. 9 and 10. For example, the eTags may have physical features (e.g., buttons and/or locks) which enable selective transmission of eTag beacons and/or the ESL server 602 may instruct the ESL AP 604 to only schedule or activate certain eTags for beacon transmission via scheduling transmissions, beacon settings information (e.g., Q-value, rate, etc.), selective energizing operations, or a combination thereof.

Alternatively, the energizers may be connected via a wired connection and may receive another (non-wireless transmission) or may transmit based on their own timing synchronization actions. The beacon synchronization or start transmission may also cause, such as by providing timing information for, other ESL and non-ESL devices (e.g., stocking device 608) to measure the DL beacon transmissions, cause devices (e.g., devices 608) to transmit UL beacon transmissions, or a combination thereof. The beacon start transmission may include or correspond to a configuration transmission. In some aspects, such as when the beacon start transmission is a Bluetooth transmission, the beacon start transmission (or beacon start message) may correspond to a Bluetooth synchronization packet.

In some aspects, the transmission broadcast by the ESL AP 604 is further configured to cause ESL controllers, including ESL controllers 606, to transmit DL beacon transmissions, cause devices (e.g., stocking device 608 and/or UEs) to measure the DL beacon transmissions, cause non-ESL devices (e.g., UEs) to transmit UL beacon transmissions, cause devices to measure the UL beacons, or a combination thereof.

After initial setup and operation of the ESL system, such as the operations at 610-620, the stocking device 608 may be loaded with products and eTags and may engage in asset stocking or restocking operations. The stocking device 608 may operate within the ESL system where its eTags receive energy from energizing signals and transmit eTag beacons, including those sent at 620. Some of these eTags are attached to products which are removed from the stocking device 608 periodically and placed on shelves. The stocking device 608 may engage in beacon measurement and reporting operations to automatically update the ESL server of a status and/or position of the eTags for enhanced asset tracking operations, including for automated updates of stocked/removed products and positions thereof. Additional details of exemplary stocking devices and stocking operations are further described with reference to FIGS. 8A, 8B, and 9.

At 625, the stocking device 608 receives one or more eTag beacons and measures the one or more eTag beacons. The stocking device 608 may perform one or more measurements on the received eTag beacons, such as signal strength measurements, signal quality measurements, directionality measurements, timing measurements, or combinations thereof. The stocking device 608 may receive the eTag beacons from one or more eTags and over one or more cycles or eTag beacon windows.

As an illustrative example, the stocking device 608 measures a first RSSI from a first beacon from a first eTag that has been removed from the stocking device 608 and a second RSSI from a second beacon from a second eTag on the stocking device 608 during a same eTag beacon window. As another illustrative example, the stocking device 608 measures a first RSSI of a first eTag beacon from a first eTag that has not yet been removed from the stocking device 608 during a first window and measures a second RSSI of a second eTag beacon from the first eTag that has been removed from the stocking device 608 during a second eTag beacon window. Although the examples illustrate simplified cases with only two beacons, in practice the stocking device 608 may receive and measure many beacons.

Additionally, or alternatively, the stocking device 608 measures AoA, ToA, RSRP, RSRQ, etc., for eTag beacons over one or more ESL cycles (e.g., eTag beacon windows). In some such aspects, the stocking device 608 may have multiple wireless radios and may be capable of generating multiple measurements for the same eTag beacon. To illustrate, a first wireless radio of the stocking device 608 may generate a first measurement for a particular eTag beacon and a second wireless radio of the stocking device 608 may generate a second measurement for the particular eTag beacon, the spatial diversity (e.g., distance) between the two radios may enable the stocking device 608 to determine if an eTag has been removed from the stocking device 608 in a single cycle. In other aspects, the multiple wireless radios may be configured to measure different beacons, and generate measurement information for each of the beacons to enable the stocking device 608 to measure multiple beacons simultaneously. As the beacons include address information, the stocking device 608 can determine the sending eTag for each beacon.

Additionally, or alternatively, a particular asset or assets (e.g., case or carton of products) may include multiple eTags and the one or more radios of the stocking device 608 may generate multiple measurements for a single asset or carton based on multiple eTag beacons associated with the particular, single asset or carton. Similarly, using multiple eTags on different places of the asset/carton may enable the stocking device 608 to generate multiple measurements for the asset/carton in a single cycle.

At 630, the stocking device 608 optionally determines a speed of the stocking device 608. For example, the stocking device 608 may utilize any conventionally known technique to determine its speed or velocity. As illustrative, non-limiting examples, the stocking device 608 may include an odometer, a speedometer, inertial sensors, accelerometer, gyroscope, camera, LiDAR, etc., or any combination thereof to determine a speed and optionally direction of the stocking device 608.

Additionally, or alternatively, the stocking device 608 may utilize ESL based positioning or location techniques to determine its speed. To illustrate, the stocking device 608 may measure UL beacons, DL beacons, eTag beacons, or a combination thereof to determine its position, and may utilize the position of the stocking device 608 to determine its speed. As an illustrative example, if the determined position of the stocking device 608 does not change over one or more ESL or beacon cycles or between different beacons, or its change in position is less than a threshold amount over such time period, the speed of the stocking device 608 may determined to be less than a threshold amount and the stocking device 608 may be determined to be stationary or at a stocking speed (e.g., a speed slow enough to enable products to be loaded and/or unloaded), as opposed to a traveling speed.

After determination of the speed, or velocity, the stocking device 608 may determine to perform one or more additional or conditional operations. In the example described in FIG. 6, the stocking device 608 may determine a location of one or more eTags, responsive to or based on the determining a speed of the stocking device 608 satisfies a speed condition (e.g., is less than or equal to a speed threshold). In such examples, the stocking device 608 may be more consistently measuring beacons for a determination of position of eTags and/or the position or speed of the stocking device 608 itself, and then the stocking device 608 only determines whether a product, i.e., an eTag or eTags associated with or coupled to the product) have been removed from the stocking device 608 based on the speed of the stocking device being under a threshold speed.

Alternatively, the stocking device 608 may determine to measure eTag beacons at 625, responsive to or based on the determining a speed of the stocking device 608 satisfies a speed condition (e.g., is less than or equal to a speed threshold) in other example. In such examples, the stocking device 608 may reduce its power consumption by only monitoring for changes in eTag position when the stocking device 608 is stationary or moving slowly. To illustrate, the stocking device 608 only monitors for and measures eTag beacons when stationary or at a stocking speed to conserve battery power.

At 635, the stocking device 608 determines eTag location information based on the eTag measurement information. For example, the stocking device 608 determines a position or positions for one or more eTags based on the eTag measurement information determined at 625. To illustrate, the stocking device 608 uses a plurality of signal strength measurements (e.g., RSRP or RSSI) to determine a distance between the eTag and the stocking device 608. As another illustration, the stocking device 608 uses a plurality of directionality measurements (e.g., AoA measurements) to determine an angle between the eTag and the stocking device 608, and from the multiple directionality measurements the stocking device 608 may determine a position (e.g., triangulation) or a position change (e.g., angle difference is greater than threshold). As yet another illustration, the stocking device 608 uses a plurality of timing measurements (e.g., ToA measurements) to determine a distance between the eTag and the stocking device 608, and from the multiple time measurements (which indicate distance) the stocking device 608 may determine a position (e.g., triangulation) or a position change (e.g., distance difference is greater than threshold). In some aspects, the stocking device 608 may use multiple types of measurements, such as RSSI and AoA, as an illustrative, non-limiting example. As illustrative examples, the stocking device 608 may determine an asset has been removed based on an RSSI variance of 10 dBm, an AoA variance of 20 degrees, a RSSI value below −30 dBm, or any combination thereof. The values are dependent on the size and shape of the stocking device 608 and the positions of the wireless radio or radios on the stocking device 608.

When the difference in position of an eTag associated with the stocking device 608 (e.g., loaded on the cart) is determined to be greater than a threshold, the stocking device 608 may determine the eTag has been unloaded from the stocking device 608 and stocked on the shelf, and associated with one or more ESLs of the ESL system. The difference in position of an eTag may be determined in multiple ways. For example, a first position of a particular eTag at a first time and a second position of the particular eTag at a second time may be used, or a position of a particular eTag and a second position of the stocking device 608 may be used to determine the difference in position for comparison to or against the threshold. Is some such aspects, the absolute position may be determined, such as by RSSI positioning for a relative position of the eTag from the stocking device 608, and then adjustment based on a position of the stocking device 608, based on its own determined position, such as by Wi-Fi, cellular (e.g., GPS), or ESL based positioning techniques. Alternatively, the relative position of the eTag from a prior position or relative to the stocking device 608 may be determined.

In some aspects, the measurements of the eTag beacons may indicate relative positioning of the eTag to the stocking device 608 and such measurement may be compared to prior measurements to determine a change in a relative position which is indicative of an eTag asset being remove/stocked. As an illustrative, non-limiting example, the stocking device 608 may determine or infer that an eTag is outside of the stocking device 608 based on one or more of the following exemplary determinations: a measured RSSI value of the eTag beacon is below a threshold value (e.g., 30 dBm); a measured AoA value of the eTag beacon lies outside a range of values (e.g., outside of −14 degrees to 15 degrees implying the signal is arriving from a direction that is away from the interior of the stocking device 608), a delta or variance between the measure RSSI and/or AoA value and a past RSSI and/or AoA value or values is greater than a threshold (e.g., an RSSI variance of 10 dBm or AoA variance of 20 deg); a measured interval between received eTag beacons drops below a certain threshold value (e.g., less than 1 beacon every 5 seconds). Beacon interval timing can be used an indicator of distance because eTag charging is a function of distance from an energizer or energizers. For example, an eTag that is farther away sees a lower energizing signal strength, and the eTag would accordingly transmit beacons less frequently since more time is required for it charge up.

After determining that an eTag has been removed from the stocking device 608, the stocking device 608 may report that event (e.g., asset remove or asset stocked) and/or position (e.g., of the cart and/or eTag) to the ESL system for stock management operations. When reporting the event and/or position to the ESL server 602 the stocking device 608 may utilize the ESL system (e.g., a local wireless connection and relay to ESL server using an ESL AP) or another communication system (e.g., cellular). Alternatively, the stocking device 608 may report the stocking event and/or event and/or position to a separate stocking server or device for stock management operations (which may be connected to or in communication with the ESL server 602).

At 640, the stocking device 608 may transmit an eTag location notification to the ESL server 602. For example, the stocking device 608 may transmit an eTag location notification transmission to the ESL server 602 which indicates or includes first eTag location information. The eTag location notification transmission may be sent via the ESL system or via a cellular network or other network connection outside of the ESL system. The first eTag location information may be associated with a position or location for an asset or product associated with the ESL system. The first eTag location information may indicate the position of the stocking device 608, a position of the eTag itself, or a position of an ESL controller of the ESL system. When the first eTag location information indicates the position of the stocking device 608 or indicates the position of an ESL controller of the ESL system, such position may be used an approximated position of the eTag.

In some implementation, the eTag location notification may include or correspond to an eTag location notification report and may include eTag location information for multiple eTags. The multiple eTags may correspond to one or more multiple products or cartons/cases of products. For example, the eTag location notification report may include the first eTag location information, second eTag location information, third eTag location information, etc.

In some aspects, the stocking device 608 transmits status information for the eTag in addition to or in the alternative of the location information. For example, the stocking device 608 may only determine or infer (with a coarser estimation or determination) that an eTag is likely to have been removed and/or stocked in the ESL system, and the stocking device 608 may report this determination or status update to the ESL server 602. The ESL server 602 may then engage in further position determination operations (e.g., operations at 655-670) to confirm the status and update the position.

In other aspects, the stocking device 608 may transmit measurement information in addition to or in the alternative of the location information. In such aspects, the ESL server 602 may determine a location or status of the eTag based on the measurement information, such as described further in the example of FIG. 7.

At 645, the ESL AP 604 may receive the eTag location notification from the stocking device 608 and may transmit or relay the eTag location notification to the ESL server 602. For example, the ESL AP 604 may relay the eTag location information of the eTag location notification transmission or report from the stocking device 608 to the ESL server 602. In some aspects, the ESL AP 604 may transmit an eTag location notification report to the ESL server 602 including eTag location notification information from multiple stocking devices, including stocking device 608, and/or from other types of devices, such as from one or more ESL controllers of the ESL controller 606 and/or from one or more UEs. Although the eTag location notification is sent via the ESL system in the example of FIG. 6, the eTag location notification may be sent via another system in other examples, such as via a cellular network.

At 650, the ESL server 602 may update eTag location information based on the eTag location notification received at 645. For example, the ESL server 602 may determine that one or more eTags have been unloaded from the stocking device 608 and have been stocked to positions of the ESL system and/or associated with corresponding ESL controllers based on the received eTag location notification from the ESL AP 604. To illustrate, the ESL server 602 may determine or infer that one or more eTags have been removed from the stocking device 608 based on an asset status indicator or change indicator, asset position/location information, asset measurement information, or a combination thereof, of the eTag location notification transmission or report, and then update a status and/or location of the eTag and/or asset in the ESL system or database of assets. Alternatively, the ESL server 602 may verify or confirm the status and/or location before updating the ESL system or database of assets. As one illustration, the ESL server 602 may update the status based on the received eTag location notification transmission and may then update the location based on further location determination operations, such as the exemplary operations of 655 to 670.

Although the example of FIG. 6 illustrates an example where a location of or associated with the eTag is reported to the ESL system and ESL server 602, in some other implementations a status of the eTag is reported to the ESL system and ESL server 602 in addition to the location information or in alternative to the location information. In such examples, the stocking device 608 may transmit eTag status information or a stocking update information for one or more eTags in the transmission at 640, and may not transmit location information for or associated with the stocking device 608 in the transmission at 640. To illustrate, the stocking device 608 may transmit eTag ID information for one or more eTags that have been determined to have been removed from the stocking device 608 based on the measurements. The stocking device 608 may optionally send its position and/or speed to the ESL server 602 in the transmission at 640, in such aspects. In such status updating aspects, the ESL server 602 may update a status of or associated with one or more eTags responsive to receiving the eTag status information or report from the stocking device 608 (e.g., directly or indirectly via the ESL AP 604).

In either of the above aspects (e.g., location or status update), the location of the eTag may be determined or further updated or refined by additional beacon-based position determination operations. In some such aspects where the position of the eTag is determined or further refined or updated, the ESL system may utilize regular periodic position determination operations for the updated eTags, or the ESL system, such as the ESL server 602, may specifically indicate or adjust a schedule to initiate eTag position determination operations for the particular updated eTag or eTags, such as described with reference to operations at 655-665.

At 655, the ESL server 602 may optionally trigger or otherwise initiate eTag beacon transmission and/or measurement. For example, the ESL server 602 may determine schedule change information based on a received indication of a status change for an eTag or eTags or a location change for an eTag or eTags. In some implementations, the ESL server 602 may determine to initiate a schedule change based on an amount of eTags that have had a status or location change. To illustrate, the ESL server 602 may broadcast or unicast a transmission to one or more ESL APs, including ESL AP 604, for relay to one or more ESL controllers, one or more stocking devices, one or more non-ESL devices, or any combination thereof. As an illustrative example, the ESL server 602 determines a group of ESL controllers of the ESL controllers 606 that are within a threshold distance of the stocking device 608 or the eTag, and transmits a wake-up message to the group of ESL controllers to scan for eTag beacons. The group of ESL controllers may also be determined based on one or more other factors, such as preset groups, aisles, rows, shelves, etc.

At 660, ESL AP 604 optionally triggers eTag beacon transmissions, eTag beacon measurements, or a combination thereof. For example, the ESL AP 604 may transmit a beacon start or synchronization transmission to initiate or provide slots for eTag beacon transmission. As another example, the ESL AP 604 may provide schedule change information to ESL controllers and/.or non-ESL devices to measure eTag beacons, or eTag beacons corresponding to the eTag beacons with updated status or position/location changes. To illustrate, the ESL AP 604 may transmit a groupcast or multicast message to a group of ESL controllers to wake-up or scan for eTag beacons during a particular time window or windows. Additionally, or alternatively, the ESL AP 604 may transmit one or more messages to energizers to trigger sending of energizing signals or to adjust the sending of an energizer signal, such as transmit more often, beamform in a direction towards the eTags, etc. In some such aspects, the energizer signaled by the ESL AP 604 is on or associated with the stocking device 608.

At 665, one or more eTags of the ESL system may transmit a beacon, eTag beacons similar to described with reference to the eTag beacons transmitted at 620. For example, energizers may transmit energizing signals to charge the eTags and/or the eTags may harvest energy from ambient wireless signals (e.g., other ESL transmissions) to harvest energy for eTag beacons. In some examples, the eTag beacons transmitted at 665 correspond to eTag beacons transmitted based on the actions of the ESL server 602 at 655 to trigger additional eTag position determination operations responsive to an eTag being determined as being removed from the stocking device 608, such as based on schedule change information 508. In other examples, the eTag beacons transmitted at 665 correspond to regularly scheduled eTag beacons according to a defined ESL schedule and beacon transmission operations, such as scheduling information 506.

At 670, one or more of the ESL controllers 606 receive the eTag beacons and measure the eTag beacons. For example, a particular ESL controller of the ESL controllers 606 may measure one or more eTag beacons from one or more eTags during a particular eTag beacon window. Additionally, the particular ESL controller may measure one or more second eTag beacons from the one or more eTags during a second particular eTag beacon window. Alternatively, the particular ESL controller may have already measured one or more prior (e.g., third eTag beacons) from the one or more eTags during a prior (e.g., third) particular eTag beacon window. The measurement information may include or correspond to signal strength measurement information, signal strength measurement information, directional measurement information, timing measurement information, or any combination thereof, similar to the measurements performed by the stocking device 608 at 625.

After 670, the ESL controllers 606 may report the measurement information to the ESL server 602 for position determination, such as via the ESL AP 604 (or via multiple ESL APs. As multiple ESL controllers may measure the same beacon and have a known static or semi-static position in the ESL system, the ESL server 602 may determine an accurate position for the eTag based on measurement information for a particular eTag beacon from multiple radios (e.g., a more accurate position than determined based on measurements from the stocking device 608). The multiple radios may correspond to a single ESL controller or multiple ESL controllers of the ESL controllers 606. Alternatively, the ESL controllers 606 or ESL AP 604 may determine a position based on the measurement information and may then provide position information for an eTag or for multiple eTags to the ESL server 602.

After 670, the ESL server 602 receives the measurement information or position information, determined from the eTag beacons at 670, from the ESL controllers 606, and the ESL server 602 may update (or confirm) a status of the eTag or eTags and/or a position/location of the eTag or eTags based on the received information. For example, if the determined position is indicative of a particular eTag still being on the stocking device 608 or still moving (e.g., change in distance over a threshold, speed over a threshold, etc.), the ESL server 602 may change the status of the asset back to being on the stocking device 608, e.g., not stocked yet, inactive, etc., from being stocked, unloaded, off the stocking device 608, or active. Additionally, or alternatively, the ESL server 602 may update or confirm a position of a particular eTag or eTags based on the measurement information from the ESL controllers 606. To illustrate, the measurement information from the ESL controllers 606 may be more accurate than the measurement information by the stocking device 608 (e.g., due to their lack of mobility or more accurate/known position), and the ESL server 602 may update the ESL position to a particular ESL or product location based on the status and/or location of the eTag as provided or derived from the measurements performed by the stocking device 608. The ESL server 602 may use similar techniques as described with reference to the stocking device 608 or as described further with reference to FIG. 10 to determine or confirm if an eTag has moved and/or the position (e.g., relative or absolute) of the eTag.

In addition to, or in alternative to the ESL controller based position determination operations at 655-670, the ESL system may utilize stocking device based position determinations operations. For example, the stocking device 608 may perform a second set of eTag beacon measurement and reporting operations, similar to the operations at 625-640, to provide the ESL server 602 with additional measurement information and/or location information (e.g., second measurement and/or location information) to enable position determination, confirmation/verification, or refinement for the eTags/assets. The ESL server 602 may update the status and position after position confirmation/verification or refinement based on the additional measurement and/or location information from the ESL controllers 606 and/or stocking device 608. After the location and/or status of the eTags being stocked are updated and/or confirmed, the ESL system, such as the ESL server 602, may engage in ESL notification operations to enable workers and users (e.g., customers) to find products or be directed to products using the ESL system.

Thus, the operations described in the example of FIG. 6 enable automated stocking status and location updates for eTags to enable an ESL system to automatically update a products status and location based on ESL position determination operations. The automated stocking operations of FIG. 6, greatly reduce the effort required in updating stock status and products locations when utilizing an ESL system. For example, a worker may no longer need to scan each product and enter a location (or scan the location) for each product when stocking to keep track of product status and/or location. Additionally, stocking may now be more easily done by or while using automated devices or machines, such as robots or AGVs, without requiring manual data entry.

Referring to FIG. 7, FIG. 7 is a timing diagram 700 illustrating an ESL system that supports enhanced asset tracking according to one or more aspects. The example of FIG. 7 corresponds to an example of enhanced asset tracking operations for a stocking device interacting with the ESL system where the ESL system (e.g., an ESL server thereof) determines a location of an eTag based on measurement information for an eTag beacon from a stocking device. The location of the eTag may be used to determine when the eTag (and a corresponding asset or assets) is/are determined to be removed from the stocking device. The example FIG. 7 may enable improved ESL functionality for automated stocking operations or for automatically updating asset locations during stocking.

In the example of FIG. 7, the ESL system includes an ESL server 702, an ESL AP 704, ESL controllers 706, and a stocking device 708 (e.g., cart, trolley, or AGV). Each of the ESL controllers 706 may include or correspond to an ESL with a wireless radio or a wireless device/radio associated with a plurality of ESLs. In the example of FIG. 7, the stocking device 708 may include one or more assets, such as cases or cartons of assets, and one or more cases/cartons or assets may include or be associated with an eTag or multiple eTags. The ESL system may optionally include or interact with one or more non-ESL devices, such as UEs.

Prior to 710, the ESL system may be configured with initial position information and/or configurations for network operation and positioning determination operations. For example, an operator may setup or preconfigure the system with initial positions for one or more devices and/or assets of the ESL systems. To illustrate, one or more of ESL APs, ESL controllers, ESLs, or assets (which may be tagged with an IoT tag) may be configured with an initial position. As another example, the ESL system may enter, such as upon initial setup, reconfiguration, or periodically (e.g., nightly weekly, monthly, quarterly, etc.), a measurement mode to determine initial or updated positions.

For example, the ESL server 702 may transmit configuration information (e.g., the configuration transmission 550 or the ESL settings information 544 of FIG. 5) to the ESL AP 704 and the ESL controllers 706. To illustrate, the ESL server 702 may transmit the configuration information directly to each device, such as by broadcast transmission or direct transmission, or the ESL server 702 may transmit the configuration information to ESL AP 704, which then transmits or relays then configuration information to one or more ESL devices, such as the ESL controllers 706. In an illustrative, non-limiting example, the ESL server 702 may transmit the configuration to ESL AP 704 via a wired connection, and the ESL AP 704 may unicast or broadcast the configuration information to the ESL devices and non-ESL devices.

As described above, the configuration information may include information configured to enable scheduling and timing coordination. For example, the configuration information may include UL and DL slot timing information for the difference devices or types/groups of devices.

Additionally, or alternatively, initial position information may be transmitted in the configuration information. For example, the operator may input a position into the ESL controllers 706, and the ESL controllers 706 may relay that position to the ESL server 702 via the ESL AP 704. As another example, the operator may configure the ESL server with the position of the ESL controllers 706, which is then relayed to the ESL controllers 706 via the ESL AP 704. As yet another example, each of the ESL controllers 706 determines its position based on a beacon of the ESL AP 704, and transmits its determined position to the ESL server 702.

At 710, the ESL server 702 may transmit stocking configuration information to the ESL AP 704 for relay to other ESL devices, other non-ESL devices, or both. For example, the ESL server 702 may unicast or broadcast a transmission to one or more ESL APs, including the ESL AP 704, which indicates or includes ESL notification configuration information. The ESL AP 704 may utilize the ESL notification configuration information to determine stocking operations configurations or modes and/or how to relay stocking notifications and/or stocking configuration information.

After 710, the ESL AP 704 may transmit stocking configuration information to one or more ESL controllers/devices, including the ESL controllers 706. For example, the ESL AP 704 may relay the stocking configuration information or transmit ESL controller stocking configuration information and/or stocking device stocking configuration information based on the received stocking configuration information from the ESL server 702. The ESL AP 704 may transmit the notification configuration information by unicast or broadcast a transmission to the one or more ESL controllers/devices. The one or more ESL controllers/devices, including the ESL controllers 706 may utilize the ESL notification configuration information to determine how to display notifications.

Additionally, or alternatively, the ESL server 702 may transmit stocking configuration information to the stocking devices for participation in the ESL system. For example, the ESL server 702 may unicast or broadcast a transmission to one or more ESL or external devices, including the stocking device 708 (e.g., smart cart or AGV), which indicates or includes ESL stocking configuration information via another, non-ESL connection (e.g., cellular). The stocking device 708 may utilize the ESL stocking configuration information to determine stocking operations configurations or modes.

At 715, the ESL AP 704 may initiate beacon transmissions by ESL devices. For example, the ESL AP 704 may transmit a beacon start or synchronization transmission, such as the broadcast transmission at 302 of FIG. 3. The beacon start or synchronization transmission may be transmitted based on timing or scheduling information received from the ESL server, such as in the stocking configuration information received at 710, or based on prior received ESL configuration information.

To illustrate, the ESL AP 704 may broadcast a transmission which is configured to cause energizers to transmit energizing transmissions. As an illustrative example, a beacon synchronization or start transmission may initiate or coordinate other actions during an ESL cycle and may provide timing or synchronization information for energizers to transmit energizing signals which may be captured by other devices, such as eTags. Then, the eTags may utilize the captured energy to transmit an ESL beacon (e.g., eTag beacon) for measurement operations by ESL and/or non-ESL devices, at 720. The eTags may also determining timing information (e.g., scheduling information and/or timing synchronization information) for when to transmit the eTag beacons from the beacon start transmission from the ESL AP 704 and/or other beacon transmissions (e.g., DL beacon transmissions from the ESL controllers 706).

Alternatively, the energizers may be connected via a wired connection and may receive another (non-wireless transmission) or may transmit based on their own timing synchronization actions. The beacon synchronization or start transmission may also cause, such as by providing timing information for, other ESL and non-ESL devices (e.g., stocking device 708) to measure the DL beacon transmissions, cause devices to transmit UL beacon transmissions, or a combination thereof. The beacon start transmission may include or correspond to a configuration transmission. In some aspects, such as when the beacon start transmission is a Bluetooth transmission, the beacon start transmission (or beacon start message) may correspond to a Bluetooth synchronization packet.

In some aspects, the ESL AP 704 may broadcast a transmission which is configured to cause ESL controllers, including ESL controllers 706, to transmit DL beacon transmissions, cause devices (e.g., stocking device 708 and/or UEs) to measure the DL beacon transmissions, cause non-ESL devices (e.g., UEs) to transmit UL beacon transmissions, or a combination thereof.

At 725, the stocking device 708 receives one or more eTag beacons and measures the one or more eTag beacons. The stocking device 708 may perform one or more measurements on the received eTag beacons, such as signal strength measurements, signal quality measurements, directionality measurements, timing measurements, or combinations thereof, similar to the measurement operations at 625 of FIG. 6. The stocking device 708 generates measurement information, similar to the measurement information of FIG. 5, and as described with reference to the measurement operations at 625 of FIG. 6. As compared to FIG. 6, the stocking device 708 of FIG. 7 may not determine a location of the eTag(s) based on the measurement information. The stocking device 708 may determine, infer or estimate a status of the eTag(s) or change in status based on the measurement information, similar to as described with reference to FIG. 6.

Prior to 730, the stocking device 708 optionally determines a speed of the stocking device 708. For example, the stocking device 708 may determine a speed or that it is stationary similar to the speed and status determination operations described at 630 of FIG. 6.

After determination of the speed, or velocity, the stocking device 708 may determine to perform one or more additional or conditional operations. In the example described in FIG. 7, the stocking device 708 may determine to report its eTag information, responsive to or based on the determining a speed of the stocking device 708 satisfies a speed condition (e.g., is less than or equal to a speed threshold). In such examples, the stocking device 708 may be more consistently measuring beacons for a determination of position of eTags and/or the position or speed of the stocking device 708 itself, and then the stocking device 708 only determines to report eTag measurement information and/or status information based on the speed of the stocking device being under a threshold speed.

Alternatively, the stocking device 708 may determine to measure eTag beacons, responsive to or based on the determining a speed of the stocking device 708 satisfies a speed condition (e.g., is less than or equal to a speed threshold). In such examples, the stocking device 708 may reduce power by only monitoring for changes in eTag position when the cart is stationary or moving slowly.

At 730, the stocking device 708 may transmit an eTag measurement notification to the ESL server 702. For example, the stocking device 708 may transmit an eTag measurement notification transmission to the ESL server 702 which indicates or includes first eTag measurement information. The eTag measurement notification transmission may be sent via the ESL system or via a cellular network or other network connection outside of the ESL system. The first eTag measurement information may be associated with a measurement of an eTag beacon and may be indicative position or location for an asset or product associated with the ESL system. The first eTag measurement information may be indicative of the position of the stocking device 708, a position of the eTag itself, or a position of an ESL controller of the ESL system. When the first eTag measurement information is indicative the position of the stocking device 708 or of the position of an ESL controller of the ESL system, such position may be used an approximated position of the eTag.

In some implementation, the eTag measurement notification may include or correspond to an eTag measurement notification report and may include eTag measurement information for multiple eTags. The multiple eTags may correspond to one or more multiple products or cartons/cases of products. For example, the eTag measurement notification report may include the first eTag location information, second eTag measurement information, third eTag measurement information, etc.

In some aspects, the stocking device 708 may transmit an eTag status indication or notification. For example, the stocking device 708 may determine that the measurement information is indicative of a potential change in status or change in position and the stocking device 708 may indicate the status change or potential status change to the ESL server 702. The ESL server 702 in such implementations may perform operations to verify the status change of the eTag(s) and/or to determine or verify a position of the eTag(s).

At 735, the ESL AP 704 may receive the eTag measurement notification from the stocking device 708 and may transmit or relay the eTag location notification to the ESL server 702. For example, the ESL AP 704 may relay the eTag measurement information of the eTag measurement notification transmission or report from the stocking device 708 to the ESL server 702. In some aspects, the ESL AP 704 may transmit an eTag location notification report to the ESL server 702 including eTag measurement notification information from multiple stocking devices, including stocking device 708, and/or from other types of devices, such as from one or more ESL controllers of the ESL controller 706 and/or from one or more UEs.

Prior to 740, the ESL server 702 optionally obtains a speed of the stocking device 708. For example, the ESL server 702 may receive a self-reported or indicated speed of the stocking device 708 from the stocking device 708, such as in the transmission received at 735 or in another transmission. As another example, the ESL server may determine or estimate a speed for the stocking device based on measuring beacon transmissions from the stocking device 708 or from assets that are located on the stocking device 708.

At 740, the ESL server 702 optionally determines whether the obtained speed of the stocking device 708 satisfies a corresponding speed condition (e.g., stocking condition). For example, the ESL server 702 may compare a received speed to a speed threshold value to determine if the ESL server 702 is stationary or at a stocking speed based on the received speed being lower than the speed threshold. The received speed may be indicated by received speed information, such as speed information in the measurement transmission at 730, or based on position information for the stocking device 708 in the measurement transmission at 730 and prior position information for the stocking device 708 in one or more prior measurement transmissions prior to 730. The measurements for position of the stocking device 708 may be based on eTag beacons and/or ESL controller beacons.

Additionally, or alternatively, the speed for the stocking device 708 may be determined based on position information provided to the ESL server 702 by the ESL controllers 706. For example, the ESL controllers 706 may receive and measure beacons sent by the stocking device 708, and provide the measurement information (or position information) to the ESL server 702 for determination of the speed of the stocking device 708.

After determination of the speed, or velocity for the stocking device 708, the ESL server 702 may determine to perform one or more additional or conditional operations. In the example described in FIG. 7, the ESL server 702 may determine to check for eTag status updates and/or confirm position updates for eTags associated with (e.g., indicated as on) the stocking device 708 but indicated as having a status update (e.g., being removed or stocked.

At 745, the ESL server 702 determines eTag location information based on the received eTag measurement information. For example, the ESL server 702 determines a position or positions for one or more eTags based on the eTag measurement information determined at 725. To illustrate, the ESL server 702 uses a plurality of signal strength measurements (e.g., RSRP or RSSI) to determine a distance between the eTag and the stocking device 708. As another illustration, the ESL server 702 uses a plurality of directionality measurements (e.g., AoA measurements) to determine an angle between the eTag and the stocking device 708, and from the multiple directionality measurements the ESL server 702 may determine a position (e.g., triangulation) or a position change (e.g., angle difference is greater than threshold). As yet another illustration, the ESL server 702 uses a plurality of timing measurements (e.g., ToA measurements) to determine a distance between the eTag and the stocking device 708, and from the multiple time measurements (which indicate distance) the stocking device 708 may determine a position (e.g., triangulation) or a position change (e.g., distance difference is greater than threshold).

When the difference in position of an eTag associated with the stocking device 708 (e.g., loaded on the cart) is greater than a threshold, the ESL server 702 may determine the eTag has been unloaded from the stocking device 708 and stocked on the shelf, and associated with one or more ESLs of the ESL system. The difference in position of an eTag may be determined in multiple ways. For example, a first position of a particular eTag at a first time and a second position of the particular eTag at a second time may be used, or a position of a particular eTag and a second position of the stocking device 708 may be used to determine the difference in position for comparison to or against the threshold.

In some aspects, the measurements of the eTag beacons may indicate relative positioning of the eTag to the stocking device 708 and such measurement may be compared to prior measurements to determine a change in a relative position which is indicative of an eTag asset being removed/stocked. As an illustrative, non-limiting example, the ESL server 702 may determine or infer that an eTag is outside of the stocking device 708 based on one or more of the following exemplary determinations: a measured RSSI value of the eTag beacon is below a threshold value (e.g., 30 dBm); a measured AoA value of the eTag beacon lies outside a range of values (e.g., outside of −14 degrees to 15 degrees implying the signal is arriving from a direction that is away from the interior of the stocking device 608), a delta or variance between the measure RSSI and/or AoA value and a past RSSI and/or AoA value or values is greater than a threshold (e.g., an RSSI variance of 10 dBm or AoA variance of 20 deg); a measured interval between received eTag beacons drops below a certain threshold value (e.g., less than 1 beacon every 5 seconds).

After determining that an eTag has been removed from the stocking device 708, the ESL server 702 may update that event and/or position (e.g., of the stocking device 708 and/or eTag) to the ESL system for stock management operations. When updating or reporting the event and/or position, the ESL server 702 update stored position information and/or status information for one or more eTags or may transmit position information and/or status information updates to a separate device or server (e.g., asset management or ERP system).

After 745, the ESL server 702 may optionally update eTag location information based on the eTag location and/or status determined at 745. For example, the ESL server 702 may determine that one or more eTags have been unloaded from the stocking device 708 and have been stocked to positions of the ESL system and/or associated with corresponding ESL controllers based on the received eTag measurement notification from the ESL AP 704. To illustrate, the ESL server 702 may determine or infer that one or more eTags have been removed from the stocking device 708 based on an asset status indicator or change indicator, asset measurement information, historical asset measurement information (e.g., from prior eTag beacon measurements by the stocking device 708 or by one or more of the ESL controllers 706), or a combination thereof, of the eTag location notification transmission or report and may update a status and/or location of the asset and eTag.

Although the example of FIG. 7 illustrates an example where measurement information indicating a status change or a location associated with the eTag is reported to the ESL system and ESL server 702, in some other implementations a status of the eTag is reported to the ESL system and ESL server 702 in addition to the measurement information or in alternative to the measurement information. In such examples, the stocking device 708 may transmit eTag status information or a stocking update information for one or more eTags in the transmission at 740, and may not transmit measurement information for or associated with the stocking device 708 in the transmission at 740. To illustrate, the stocking device 708 may transmit eTag ID information for one or more eTags that have been estimated to have been removed from the stocking device 708 based on the measurements. The stocking device 708 may optionally send its position and/or speed to the ESL server 702 in the transmission at 740, in such aspects. In such status updating aspects, the ESL server 702 may update a status of or associated with one or more eTags responsive to receiving the eTag status information or report from the stocking device 708 (e.g., directly or indirectly via the ESL AP 704).

In either of the above aspects (e.g., measurement or status update), the location of the eTag may be determined or further updated or refined by additional beacon-based position determination operations. In some such aspects where the position of the eTag is determined or further refined or updated, the ESL system may utilize regular periodic position determination operations for the updated eTags, or the ESL system, such as the ESL server 702, may specifically indicate or adjust scheduled operations to initiate eTag position determination operations for the particular updated eTag or eTags, such as described with reference to operations at 755-765. In some aspects, where only measurement information and/or status information is provided to the ESL server 702, the ESL server 702 may not be able to generate a position for the eTag or an accurate position for the eTag, and the ESL server 702 may engage in ESL controller based measurement and position determination to determine or verify the position or status of the eTag.

At 750, the ESL server 702 may optionally trigger or otherwise initiate eTag beacon transmission and/or measurement. For example, the ESL server 702 may determine schedule change information based on a received indication of a status change for an eTag or eTags or a location change for an eTag or eTags. In some implementations, the ESL server 702 may determine to initiate a schedule change based on an amount of eTag that have had a status or location change. To illustrate, the ESL server 702 may broadcast or unicast a transmission to one or more ESL APs, including ESL AP 704, for relay to one or more ESL controllers, one or more stocking devices, one or more non-ESL devices, or any combination thereof.

At 755, ESL AP 704 optionally triggers eTag beacon transmissions, eTag beacon measurements, or a combination thereof. For example, the ESL AP 704 may transmit a beacon start or synchronization transmission to initiate or provide slots for eTag beacon transmission. As another example, the ESL AP 704 may provide schedule change information to ESL controllers and/.or non-ESL devices to measure eTag beacons, or eTag beacons corresponding to the eTag beacons with updated status or position/location changes.

At 760, one or more eTags of the ESL system may transmit a beacon, eTag beacons similar to described with reference to the eTag beacons transmitted at 720. For example, energizers may transmit energizing signals to charge the eTags and/or the eTags may harvest energy from ambient wireless signals (e.g., other ESL transmissions) to harvest energy for eTag beacons. In some examples, the eTag beacons transmitted at 765 correspond to eTag beacons transmitted based on the actions of the ESL server 702 at 755 to trigger additional eTag position determination operations responsive to an eTag being determined as being removed from the stocking device 708. In other examples, the eTag beacons transmitted at 765 correspond to regularly scheduled eTag beacons according to a defined ESL schedule and beacon transmission operations.

At 765, one or more of the ESL controllers 706 receive the eTag beacons and measure the eTag beacons. For example, a particular ESL controller of the ESL controllers 706 may measure one or more eTag beacons from one or more eTag beacons during a particular eTag beacon window. Additionally, the particular ESL controller may measure one or more second eTag beacons from one or more eTag beacons during a second particular eTag beacon window. Alternatively, the particular ESL controller may have already measured one or more prior (e.g., third eTag beacons) from one or more eTag beacons during a prior (e.g., third) particular eTag beacon window. The measurement information may include or correspond to signal strength measurement information, signal strength measurement information, directional measurement information, timing measurement information, or any combination thereof, similar to the measurements performed by the stocking device 708 at 725.

After 765, the ESL controllers 706 may report the measurement information to the ESL server 702 for position determination, such as via the ESL AP 704 (or via multiple ESL APs. As multiple ESL controllers may measure the same beacon, the ESL server 702 may determine an accurate position for the eTag based on measurement information for a particular eTag beacon from multiple radios. The multiple radios may correspond to a single ESL controller or multiple ESL controllers. Alternatively, the ESL controllers or ESL AP may determine a position based on the measurement information and may then provide position information for an eTag or for multiple eTags to the ESL server 702.

After 765, the ESL controllers 706 report the measurement information or position information determined from the eTag beacons at 770, the ESL server 702 may update (or confirm) a status of the eTag or eTags and/or a position/location of the eTag or eTags. For example, if the position is indicative of a particular eTag still being on the stocking device 708 or still moving (e.g., change in distance over a threshold, speed over a threshold, etc.), the ESL server 702 may change the status of the asset back to on the stocking device 708, not stocked yet, inactive, etc. from being stocked, unloaded, off the cart, or active. Additionally, or alternatively, the ESL server 702 may update or confirm a position of a particular eTag or eTags based on the measurement information from the ESL controllers. To illustrate, the measurement information from the ESL controllers may be more accurate than the measurement by the stocking device 708, and the ESL server 702 may update the ESL position to a particular ESL or product location based on the status and/or location of the eTag as provided or derived from the measurements performed by the stocking device 708.

After the location and/or status of the eTags being stocked are updated and/or confirmed, the ESL system, such as the ESL server 702, may engage in ESL notification operations to enable workers and users (e.g., customers) to find products or be directed to products using the ESL system.

Thus, the operations described in the example of FIG. 7 enable automated stocking status and location updates for eTags to enable an ESL system to automatically update a products status and location based on ESL position determination operations. The automated stocking operations of FIG. 7, greatly reduce the effort required in updating stock status and products locations when utilizing an ESL system. For example, a worker may no longer need to scan each product and enter a location (or scan the location) for each product when stocking. Additionally, stocking may now be more easily done by or while using automated devices or machines, such as robots or AGVs, without requiring manual data entry.

FIGS. 8A and 8B are each a diagram illustrating an example of a stocking device for enhanced asset tracking operations according to some aspects described herein. The ESL systems described herein may include or be associated with one or more stocking devices to enable automated stocking operations of assets and automated asset status and position updates for the assets.

Referring to FIG. 8A, FIG. 8A is a block diagram 800 illustrating an example of a stocking device 802 for enhanced asset tracking operations. As illustrated in the block diagram 800, an example of a stocking device 802 for a retail or warehouse environment with ESL devices and assets with eTags according to some embodiments of the disclosure is illustrated.

The stocking device 802 includes one or more processors and one or more memories. In the example of FIG. 8A, the stocking device 802 includes a representative processor, processor 812, and a representative memory, memory 814. The stocking device 802 also includes one or more wireless radios 816 (e.g., ESL radios). The one or more wireless radios 816 may be configured to perform ESL beacon transmission operations and beacon measurement operations. For example, the wireless radios 816 may be configured to transmit beacons for measurement by ESL devices, and may be configured to receive and measure eTag beacons and/or ESL beacons for generating measurement information.

The processor 812 and memory 814 may be configured to store the measurement information and optionally to perform position and/or status determination operations based on the measurement information, as described with reference to FIGS. 5-7. For example, the processor 812 may utilize historical measurement information for an eTag corresponding to prior eTag beacons and current measurement information for the eTag from an eTag beacon during a particular beacon window to determine if a change in the measurement information (e.g., RSSI, AoA, ToA, or a combination thereof), satisfies a corresponding threshold value and indicates a change in position indicative of the eTag and product being removed from the stocking device 802 and placed on a shelf associated with an ESL.

The stocking device 802 optionally includes one or more energizers 818. The one or more energizers 818 are configured to transmit energizing signals or waveforms, which may be received by eTags, and their energy harvested for eTag beacon operations. The one or more energizers 818 may include or correspond to any of the energizers described herein. The energizer may include or correspond to a device which transmits wireless signals for power harvesting by eTags, and the eTags may include or correspond to the eTags 593 of FIG. 5. In some aspects, the energizer could be an ESL AP, ESL controller, or UE device. For example, the eTags may harvest energy from ambient ESL RF signals as opposed to dedicated energizer signals. For example, the energizer 804 may broadcast a signal in one or more directions with signal characteristics that enable external devices to harvest the RF energy and convert it to power. For example, the energizer 804 may transmit a signal with a particular frequency (e.g., in a 500-3500 MHz range) and/or a particular waveform type (e.g., a Sinusoidal waveform), as one illustrative, non-limiting example.

The stocking device 802 optionally includes one or more of a navigation system 820, an inertial sensor(s) 822, an optical sensor 824, or a movement system 826. For example, when the stocking device 802 corresponds to an AGV, a robot, or another automated device, the stocking device 802 may be configured to move throughout the ESL environment, such as a retail store, a warehouse, a storage area, etc., automatically and independent of a user pushing or guiding the stocking device 802. In some such aspects, the stocking device 802 may include the navigation system 820 to navigate the ESL environment. The navigation system 820 is configured to guide the stocking device 802 from location to location throughout the ESL environment and may utilize ESL based position information determined from the wireless radio(s) 816, inertial information from the inertial sensor(s) 822, optical information from the optical sensor(s) 824, or any combination thereof. The navigation system 820 may be configured to control the movement system 826 of stocking device 802 to direct the movement system 826 to drive the stocking device 802 from location to location.

As an illustrative, non-limiting example, the movement system 826 may include or correspond to an electric drive system, such as having one or more electric motors, a transmission or transmissions, and one or more batteries. Alternatively, the movement system 826 may include a fuel (e.g., gasoline) powered engine-based drive system. The movement system 826 may optionally include an odometer or speed based sensor configured to generate speed information or to indicate a movement status of the stocking device 802, e.g., stationary, in transit, at a stocking speed, etc.

The inertial sensor(s) 822 may include or correspond to accelerometers, gyroscopes, or other inertia-based sensors. The inertial sensor(s) 822 may be configured to output inertial information to the navigation system 820 to enable the navigation system 820 to determine and update its position. The initial position or subsequent positions may also be updated based on other information that indicates position obtained by the stocking device 802, such as ESL based position information (e.g., measuring beacons from other ESL devices or transmitting beacons to other ESL devices to enable the ESL devices to generate measurement information for the stocking device).

The optical sensor(s) 824 may include or correspond to a camera or computer vision system. The optical sensor(s) 824 may be configured to interpret visual notifications or guidance information displayed by ESLs of the ESL system. For example, the ESLs may output color-based indications and/or machine readable information (e.g., barcodes, QR codes, etc.) to help provide navigation information and/or position information to the stocking device 802 based on a position of the stocking device 802 determined from a camera or cameras associated with the ESL system or environment and/or based on ESL determined position information.

The stocking device 802 is configured to carry or store one or more products 832 and one or more eTags 834 associated with the products 832. The products 832 and the eTags 834 may be loaded onto the stocking device 802 for stocking or restocking operations and then taken off the stocking device 802 and placed onto the shelves 202A. As described above, the stocking device 802 may determine that an asset has been removed and inform the ESL system of its status and/or position or provide measurement information to the ESL system to enable the ESL system to determine the status and/or position of the eTag and asset. Operations of a stocking device, such as stocking device 802, are described with reference to FIGS. 5-7 and are further described with reference to FIG. 9.

Referring to FIG. 8B, FIG. 8B is a diagram 850 illustrating an example of enhanced asset tracking operations for asset stocking. As illustrated in the diagram 850, an isometric view of an exemplary smart cart or trolley type stocking device, cart 852, for a retail or warehouse environment with ESL devices and assets with eTags according to some embodiments of the disclosure is illustrated. The cart 852 may include or correspond to a stocking device as described herein, such as the wireless device 503 of FIG. 5 and/or the stocking device of FIGS. 6-8A.

In the example of FIG. 8B, the cart 852 includes an energizer 862, multiple wireless radios 864, and multiple products 866. The energizer 862 may include or correspond to the energizer 818 of FIG. 8A or as described in any of the previous FIGS. The multiple wireless radios 864 may include or correspond to the wireless radios 816 of FIG. 8A or the wireless device 503 of FIG. 5. The multiple products 866 may include or be associated with one or more eTags, such as the eTags 593 of FIG. 5. For example, eTags may be incorporated into one or more of the products, attached or affixed to the products or a carton or case that holds multiple products.

As illustrated in FIG. 8B, the wireless radios are spaced apart from one another to enable spatial diversity. The spatial diversity may enable the cart 852 to generate multiple measurements (e.g., first and second measurement information) and more accurate measurement information for a single beacon and may enable generation or determination of a change in status or position in a single beacon window. Operations of a stocking device, such as cart 852, are described with reference to FIGS. 5-7 and are further described with reference to FIG. 9.

FIG. 9 is a diagram 900 illustrating an example of enhanced asset tracking operations for asset stocking. As illustrated in the diagram 900, a top-down view of a retail or warehouse environment with ESL devices accessible to a stocking device according to some embodiments of the disclosure is illustrated.

The ESL devices may provide information to a shopper or store employee operating in the environment, such as to provide information regarding products and/or assist with location determination of products or the /er/ employee. Additionally, in the aspects described herein, the ESL devices may provide information to a stocking device, or a user associated with a stocking device to enable the user and/or stocking device to navigate the ESL environment and stock assets.

In the diagram 900 of FIG. 9, a stocking device 902 is navigating an aisle or being pushed through the aisle by a user or employee. The stocking device 902 may use eTag beacons to determine a status and location for an asset or assets associated with the beacon using the ESL system and infrastructure. For example, a UE (ESL/wireless radios) associated with the stocking device 902 determines a status and/or position of an asset as the stocking device 902 moves through the aisle. In some aspects, as described with reference to FIGS. 6 and 7, the stocking device 902 may measure and/or make status and/or position determinations based on a speed of the stocking device 902, such as responsive to the stocking device 902 being stationary or below a particular threshold speed.

The stocking device 902 may be guided to a desired location for stocking a particular product by its own navigation system or by ESL based positioning techniques. As illustrated in the example, of FIG. 9, the stocking device 902 is used to stock three different types of assets in three different locations. During each stocking (or restocking), the stocking device 902 may pause at a particular location and measure eTag beacons. The stocking device 902 then transmits the measurements to the ESL server. Additionally, or alternatively, the stocking device 902 transmits a status (e.g., asset removed or stocked) and/or position of the eTag based on the measurements.

At a first time, the stocking device 902 navigates to a first location 910 and pauses to unload one or more first assets having a first type. The assets may be in carton or case, and the assets are associated with one or more eTags, such as first eTags. The first eTags may receive energy from ESL transmissions, energizer transmissions, or other wireless transmissions, and may each transmit an eTag beacon, first eTag beacons, when charged and during an eTag beacon window (e.g., first eTag beacon window). The wireless radios of the stocking device 902 measure the first eTag beacon or beacons from the first eTag or eTags and generate measurement information. The stocking device 902 reports the measurement information for the first eTag or eTags to the ESL server. The stocking device 902 may also report its position, its speed, its status (e.g., stationary/stocking), the eTag's or asset's status, or any combination thereof to enable the ESL server to update and/or determine a status and/or position for the first eTags.

At a second time, the stocking device 902 navigates to a second location 912 and pauses to unload one or more second assets having a second type. The assets may be in carton or case, and the assets are associated with one or more eTags, such as second eTags. The second eTags may receive energy from ESL transmissions, energizer transmissions, or other wireless transmissions, and may transmit an eTag beacon, second eTag beacons, when charged and during an eTag beacon window (e.g., second eTag beacon window). The wireless radios of the stocking device 902 measure the second eTag beacon or beacons from the second eTag or eTags and generate measurement information. The stocking device 902 may determine a status of the second eTag or eTags. For example, based on a measurement value, such as an AoA, being greater than an angle threshold or a difference between the measurement value and a prior measurement value being greater than an angle difference threshold, the stocking device 902 may determine the second eTag has been stocked. The stocking device 902 transmits the status information to the ESL server. The stocking device 902 may optionally transmit the measurement information to the ESL server as well, in addition to or in the alternative of, its position, its speed, its status (e.g., stationary/stocking), the eTag's or asset's status, or any combination thereof to enable the ESL server to update and/or determine a status and/or position for the second eTags.

At a third time, the stocking device 902 navigates to a third location 914 and pauses to unload one or more third assets having a third type. The assets may be in carton or case, and the assets are associated with one or more eTags, such as third eTags. The third eTags may receive energy from ESL transmissions, energizer transmissions, or other wireless transmissions, and may transmit an eTag beacon, third eTag beacons, when charged and during an eTag beacon window (e.g., third eTag beacon window). The wireless radios of the stocking device 902 measure the third eTag beacon or beacons from the third eTag or eTags and generate measurement information. The stocking device 902 may determine a status and position of the third eTag or eTags. For example, based on multiple measurement values, such as RSSI, the stocking device 902 may determine a position of the third eTag. The stocking device 902 may determine that the third eTag has been stocked based on the determined position being different from a prior position, such as by greater than a threshold amount of inches or centimeters. The stocking device 902 transmits the status information and the position information to the ESL server. The stocking device 902 may optionally transmit the measurement information to the ESL server as well, in addition to or in the alternative of, its position, its speed, its status (e.g., stationary/stocking), the eTag's or asset's status, or any combination thereof to enable the ESL server to update and/or determine a status and/or position for the third eTags. Although not described in the example of FIG. 9, the stocking device 902 may utilize its own speed and/or position information to determine when it is stocking assets or moving slow enough to stock assets and may only perform such measurements and/or reporting when such conditions are satisfied.

After stocking the particular products, the ESL system may determine a position (e.g., an updated or refined position) of the stocked assets/eTags based on ESL based positioning techniques. For example, ESL devices and/or non-ESL devices may measure eTag beacons (e.g., second eTag beacons) and relay the measurement to the ESL server for position determination or up[date/refinement, as described with reference to FIGS. 6 and 7.

In some aspects, ML or AI techniques may be used to determine whether an eTag is in the stocking device 902 or not, or whether the eTag has been removed or stocked. For example, a model may be trained and used to classify a status of the eTag and corresponding asset. The model may be stored at the stocking device 902 and run locally or may be stored at the ESL server. The input to the model may be one or more of cart speed, cart position, eTag beacon measurement information, eTag beacon position, or any combination thereof. The eTag beacon measurement information may include any of signal strength, signal/beam angle, transmission timing, or signal quality measurements.

In some aspects, eTags that are currently on a stocking cart may cause interference to other eTags, such as those attached to other unstocked assets or cases being unloaded or other stocked assets on the shelves. In the aspects described herein, techniques for reducing eTag interference are described. One way that eTag interference may be reduced, is by reducing the amount or rate of beacons from eTags. For example, the ESL system may reduce the beacon amount or rate of eTags being stocked (e.g., on the cart but not removed), eTags that are already stocked, or eTags that are in transition and/or have recently been stocked. Illustrative examples of reducing the rate or amount of beacons include reducing the beaconing rate or Q-value. These values may be included in configuration information or control information (e.g., WUS-D) of the energizing signal or beacon synchronization/start signal. Accordingly, eTag status can be used to reduce eTag beacon rates or amounts.

Another way to reduce eTag interference may include utilizing a physical button or locking mechanism that can be used to either trigger eTag beacon transmissions in an on-demand manner and/or that can prevent eTag transmissions until activation or unlock. For example, an eTag may include a mechanical switch which can be activated (e.g., pressed) to prompt an eTag beacon. As another example, the eTag may include a magnetic switch which can be activated by use of a magnet or magnetic force change (e.g., removal of a magnet or placing of magnet). The magnet may be attached to a carton or case of products that eTags are activated upon breaking of a magnet coupling associated with breaking seal of the carton or case.

As yet another way, the ESL system may utilize speed to reduce beacon amounts or beacon rates. The ESL system may utilize speed and/or status to determine which eTags to reduce beacons. For example, the ESL system may determine or infer which tags are loaded on the cart and may utilize an estimated or reported speed of the cart to reduce beacon amounts or rates. As an illustrative example, the Q-value and/or beaconing rate can be adjusted for the eTag beacons (or for energizing signals from the cart or transmitted near the cart). In some aspects, the level of interference reduction and/or change in Q-value or beaconing rate may depend on or be proportional to a speed of the cart. As another illustrative, example, the energizers may beamform or directionally send their energizing waveforms to reduce or prevent energy harvesting by the eTags on the cart. For example, the energizer on the cart may refrain from sending energizing signals for a period of time or reduce its periodicity for energizing signals and/or the energizer on the cart may direct one or more of its energizing signals away from the cart. By reducing beacons from eTags loaded on the cart, especially when the cart is moving above a stocking speed or not stationary, eTag beacons which are not likely to cause status updates or position updates (e.g., because products are not being unloaded) are not transmitted and do not cause interference. When an eTag is inferred to be within the cart, the current location of the cart may be used as a proxy for the location of the eTag. In this case, the ESL radios do not need to be triggered, thereby conserving power. Any of the above ways to reduce interference can be used in combination with one another to reduce the interference in multiple ways.

Conversely, for products that have been recently unloaded the ESL system may want to increase beacons from the associated eTags for status and/or position confirmation. For example, the opposite of the above techniques to slow eTag beacons can be used to increase eTag beacons. Schedule change information can be sent to enable specific eTag beacon transmission and measurement, beamforming energizing signals and/or additional energizing signals may increase eTag beacons or reduce charging time, reducing a Q-value can be used to increase eTag beacon transmission, or any combination thereof.

FIG. 10 is a timing diagram 1000 illustrating an example of a timing schedule for ESL communications. As illustrated in the timing diagram 1000, the ESL system includes multiple scheduling schemes and/or time windows for different devices. The timing diagram 1000 includes a beacon timing portion or DL portion time scheme 1002, similar to the timing diagram of FIG. 3.

The timing diagram 1000 also includes an energizer time scheme 1004 shown with respect to the beacon timing portion or DL portion time scheme 1002, where energizing devices transmit energizing signals to eTags. For example, the energizer time scheme 1004 may include transmission of energizing signals sent during a DL portion of the ESL network. The energizing signals may include timing information, such as wake-up and/or synchronization information for eTags. In other implementations, energizers may not be used, and ESL radios or ESL APs may transmit similar “energizing” transmissions in addition to or in the alternative of the energizers. As an illustrative example, the wake-up signal may include multiple portions, such as a preamble portion (WUS-P) and a data portion (WUS-D), as illustrated in the example of FIG. 10.

The timing diagram 1000 further includes an uplink portion time scheme 1006 shown with reference to eTag transmissions. As described above, the slots of the uplink portion will not always be used by the eTags, as eTags may not be present in the system, may still be charging, or may be performing a random backoff within the window. This UL portion may be repurposed by the ESL system to enable devices, such as mobile devices or UEs, to transmit UL beacon transmissions or requests to the ESL system as described in the above description.

The UL portion may include one or more UL windows, and each UL window may include or more slot, and one or more subframes thereof depending on the numerology. As illustrated in the example of FIG. 10, an UL portion includes a single UL window that includes multiple slots. Each slot may include multiple subframes, such as 2, 4, 6, etc. The UL portion may occur anywhere during the ESL cycle, such as prior to a DL portion (e.g., beacon, energizer, or both), after a DL portion, between two DL portions, etc. In the example of FIG. 10, the UL portion comes after the initial transmission from the ESL AP (e.g., ESL beacon start transmission) and before the responses from the ESLs (e.g., ESL beacons) and Energizer transmissions.

The timing diagram 1000, and portions thereof, may represent a base scheduling scheme that is indicated by scheduling/timing information or ESL configuration information. The timing diagram 1000, and portions thereof, may be adjusted by schedule change information, such as UL schedule change information, DL schedule change information, or both. The schedule change information may indicate additional UL slots or grants for UEs, additional DL slot or grants for beacons, removal of UL slots for eTags, and/or removal of DL slots for ESL devices (e.g., ESL controllers).

During operation, an eTag may start with energy harvesting (or always be passively energy harvesting) from ESL transmission RF energy to charge a circuit. Once the energy harvested satisfies a threshold, such as a voltage thresholds (e.g., 0.5 to 1.5 volts) the eTag may begin a transmission process. For example, the eTag may monitor for a wake-up signal (e.g., WUS-P) or a peak associated therewith to determine when to send a beacon transmission. In some aspects, the eTag may determine whether the wake-up signal satisfies a received power threshold, such as RSSI, in order to filter out wake-up signals that are farther away and/or for other eTags or to determine to perform a backoff procedure. When performing the backoff procedure, the eTag may determine a Q-value and perform a random backoff by selecting M subframes to sleep for between zero and Q. The Q-value may be known to the eTag prior to wake-up or receiving the energizing signal, such as pre-programmed or configured prior to the energy harvesting and energizing signal, or may be indicated by the energizing signal, such as by the WUS-P or WUS-D thereof.

After performing the random backoff, i.e., waiting M subframes, the eTag may transmit perform a clock synchronization operation and transmit in one of the UL slots. After transmission, the eTag will charge again and repeat the process. In some aspects, the eTag will delay a particular number of subframes, such as N, and stay silenced for the subframes before attempting to transmit again (e.g., determine whether the voltage condition is satisfied).

The eTag charging time is well correlated with distance from received signals, such as received ESL beacon transmissions. The eTag charging time may increase exponentially with increasing distance from a beacon (and the corresponding decreasing signal strength associated with the increased distance).

Position estimation as described herein may utilize RSSI, AoA, and/or TOA. In some aspects, the position estimation utilizes RSSI to enable lower complexity devices to engage in measurement operations for position estimation. Other signal quality or strength metrics may be used, such as RSRP or RSRQ.

In some aspects, a centroid algorithm may be used to determine position, such as known in the ESL position determination art. Trilateration using RSSI has been observed to be highly unreliable since the RSSI is very susceptible to attenuation, which in turn leads to poor range estimation accuracy. Instead, a Weighted Centroid Algorithm (WCA) has been observed to be much more robust to attenuation and no-line-of-sight (NLOS) effects. A device, e.g., UE or eTag, position may be estimated by a weighted average of ESL radio positions where the weights are functions of RSSI values.

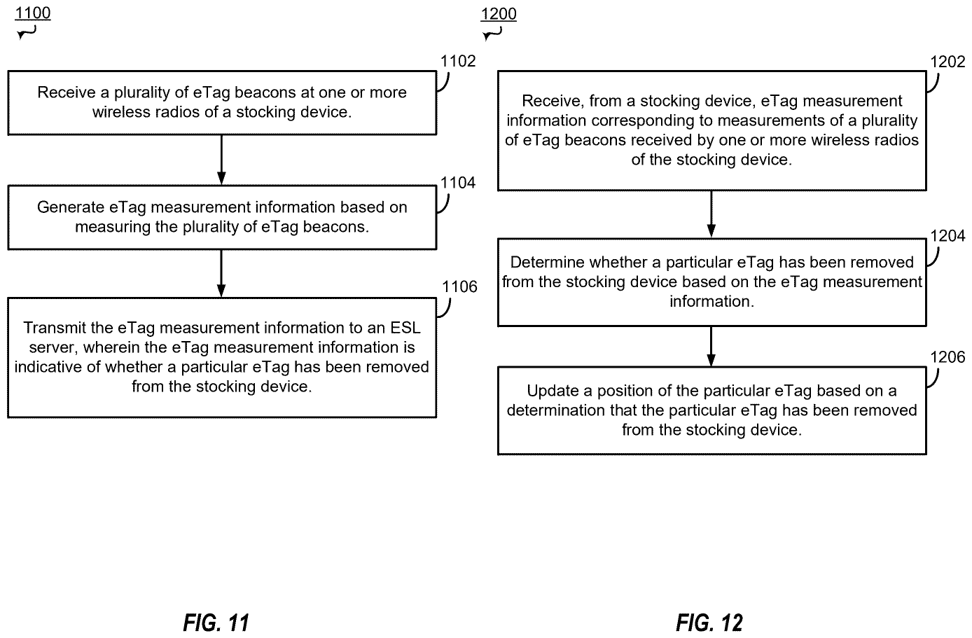

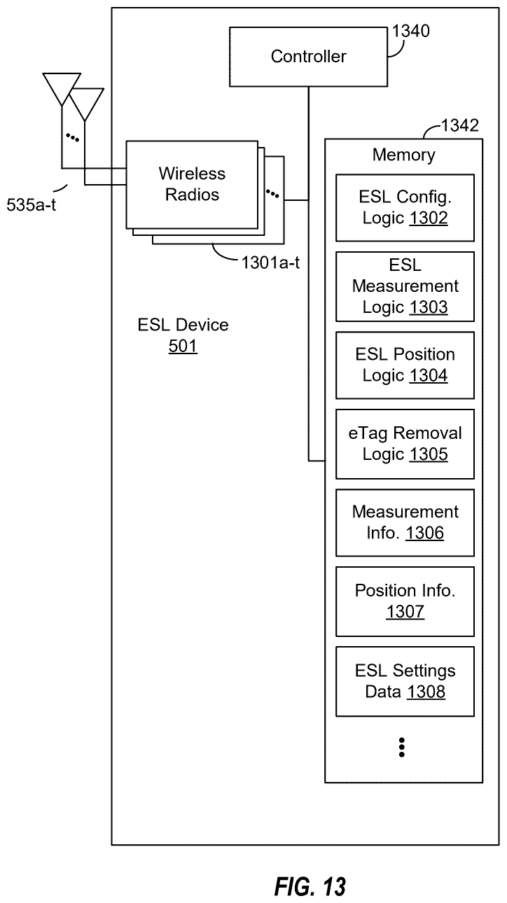

FIG. 11 is a flow diagram 1100 illustrating example blocks executed by wireless communication device (e.g., an ESL device or a UE) configured according to an aspect of the present disclosure. The example blocks will also be described with respect to ESL device 501 as illustrated in FIG. 13. FIG. 13 is a block diagram illustrating ESL device 501 configured according to one aspect of the present disclosure. ESL device 501 includes the structure, hardware, and components as illustrated for ESL device 501 of any of FIG. 5. For example, ESL device 501 includes controller/processor 1340, which operates to execute logic or computer instructions stored in memory 1342, as well as controlling the components of ESL device 501 that provide the features and functionality of ESL device 501. ESL device 501, under control of controller/processor 240, transmits and receives signals via wireless radios 1301a-t and antennas 535a-t. As illustrated in the example of FIG. 13, memory 1342 stores one or more of ESL configuration logic 1302, ESL measurement logic 1303, ESL position logic 1304, ESL eTag removal logic 1305, measurement information 1306 (e.g., beacon and/or speed measurements), position information 1307, or ESL settings data 1308. The data (1302-1308) stored in the memory 242 may include or correspond to data and/or logic to enable the operations of FIGS. 5-10F.

At block 1102, a wireless communication device, such as stocking device or smart cart, receives a plurality of electronic tag (eTag) beacons at one or more wireless radios of a stocking device. The plurality of eTag beacons may include or correspond to any of the eTag beacons as described in any of FIGS. 5-9, such as beacons sent by the eTags 593 or eTags 834, including the beacon transmissions 552 and/or 556, the eTag beacons sent at 620 of FIG. 6, or the eTag beacons sent at 720 of FIG. 7. The one or more wireless radios may include or correspond to a wireless radio or ESL radio of a stocking device, such the wireless radios 816 of FIG. 8A or 864 of FIG. 8B. The stocking device may include or correspond to any of the stocking devices as described in any of FIGS. 5-9, such as wireless device 503, stocking device 608, stocking device 708, stocking device 802, cart 852, or stocking device 902. For example, the wireless device 503 receives the beacon transmissions 552 from one or more eTags 593 that are associated with the wireless device 503, such as loaded on a stocking device, as described with reference to FIG. 5. As another example, the stocking device 608/708 receives beacon transmissions at 620/720, as described with reference to FIGS. 6 and 7. Other examples are also described in FIGS. 5-9.

At block 1104, the wireless communication device generates eTag measurement information based on measuring the plurality of eTag beacons. The eTag measurement information may include or correspond to measurement information 542 or eTag Report transmission, such as the eTag Report transmission 554 of FIG. 5, the eTag location notification transmission transmitted at 640 of FIG. 6, or the measurement Report transmission transmitted at 730 of FIG. 7. For example, the wireless device 503 measures eTag beacons and generates measurement information 542. As another example, the stocking device 608/708 measures eTag beacons at 620/725 and generates measurement information based on measuring the eTag beacons.

At block 1106, the wireless communication device transmits the eTag measurement information to an electronic shelf label (ESL) server, wherein the eTag measurement information is indicative of whether a particular eTag has been removed from the stocking device. The ESL server may include or correspond to the ESL device 501, the ESL server 602, or the ESL server 702. For example, the wireless device 503 transmits the eTag report transmission 554 including the measurement information 542. As another example, the stocking device 608/708 transmits the eTag location notification transmission at 640 of FIG. 6, or the measurement Report transmission at 730 of FIG. 7. Other examples are also described in FIGS. 5-9.

The wireless communication device (e.g., UE or ESL device) may execute additional blocks (or the wireless communication device may be configured further to perform additional operations) in other implementations. For example, the wireless communication device, such as one or more processors and one or more memories (e.g., a processing system) thereof, may perform one or more operations described above, such as described with reference to FIGS. 5-10 or as described below. As another example, the wireless communication device may perform one or more aspects as presented below.

Accordingly, wireless communication devices may perform enhanced notification coexistence operations to dynamically and flexibly leverage ESL notification resources to output position or location based operations, such as to output multiple notifications concurrently in close proximity to one another. In some aspects, the wireless communication devices may utilize proximity based thresholds to determine when to perform the notification coexistence operations. Additionally, notification information may be provided to the devices to enable notification synching by the devices with the notifications output by the ESLs. Accordingly, the network performance and user experience may be increased due to increased notification bandwidth and clarity.

FIG. 12 is a flow diagram 1200 illustrating example blocks executed by wireless communication device (e.g., a UE or an ESL device) configured according to an aspect of the present disclosure. The example blocks of FIG. 12 will also be described with respect to ESL device 501 as illustrated in FIG. 13. The example blocks of FIG. 12 may be practiced by any of the ESL devices described herein.

At block 1202, a wireless communication device, such as an ESL device (e.g., ESL server), receives, from a stocking device, electronic tag (eTag) measurement information corresponding to measurements of a plurality of eTag beacons received by one or more wireless radios of the stocking device. The stocking device may include or correspond to any of the stocking devices as described in any of FIGS. 5-9, such as wireless device 503, stocking device 608, stocking device 708, stocking device 802, cart 852, or stocking device 902. The eTag measurement information may include or correspond to measurement information 542 or an eTag Report transmission, such as the eTag Report transmission 554 of FIG. 5, the eTag location notification transmission transmitted at 640 of FIG. 6, or the measurement Report transmission transmitted at 730 of FIG. 7. The plurality of eTag beacons may include or correspond to any of the eTag beacons as described in any of FIGS. 5-9, such as beacons sent by the eTags 593 or eTags 834, including the beacon transmissions 552 and/or 556, the eTag beacons sent at 620 of FIG. 6, or the eTag beacons sent at 720 of FIG. 7. The one or more wireless radios may include or correspond to a wireless radio or ESL radio of a stocking device, such the wireless radios 816 of FIG. 8A or 864 of FIG. 8B. For example, the ESL device 501 receives the eTag report transmission 554 including the measurement information 542 or receives the eTag location notification transmission transmitted at 640 of FIG. 6, or the measurement Report transmission transmitted at 730 of FIG. 7. Other examples are also described in FIGS. 5-9.

At block 1204, the wireless communication device determines, whether a particular eTag has been removed from the stocking device based on the eTag measurement information. The particular eTag may include or correspond to any of the eTags described herein, such as an eTag of the eTags 593 of FIG. 5 or 834 of FIG. 8. For example, the ESL device 501 or the ESL server 602/702 determines a position based on the measurement information. As another example, the ESL device 501 or the ESL server 602/702 determines whether the measurement information exceeds one or more corresponding conditions, and determines that a particular eTag has been removed based on the measurements satisfying the one or more conditions (e.g., exceeding a threshold). In some such aspects, the device may also utilize speed information from the stocking device in order to determine whether the particular eTag has been removed from the stocking device. Other examples are also described in FIGS. 5-9. To illustrate, the ESL device 501 or the ESL server 602/702 may receive position information and/or an indication instead of measurement information and may determine whether the eTag has been removed based on the position information and/or an indication.

At block 1206, the wireless communication device update a position of the particular eTag based on a determination that the particular eTag has been removed from the stocking device. The position may include or correspond to the position information 545 of FIG. 5, and may indicate a position of one or more eTags. For example, the ESL device 501 or the ESL server 602/702 updates a stored position, such position information 545, based on a determination that an eTag associated with a stocking device has been removed (e.g., a product including the eTag has been stocked). Other examples are also described in FIGS. 5-9.

The wireless communication device (e.g., such as a UE or base station) may execute additional blocks (or the wireless communication device may be configured further to perform additional operations) in other implementations. For example, the wireless communication device may perform one or more operations as described with reference to FIGS. 5-11 or as described below. As another example, the wireless communication device may perform one or more aspects as presented below.

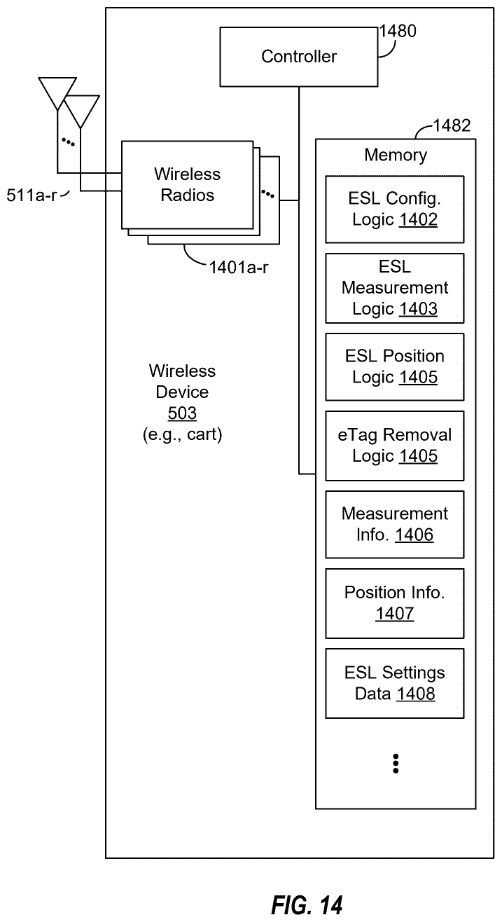

FIG. 14 is a block diagram illustrating wireless device 503 configured according to one aspect of the present disclosure. Wireless device 503 includes the structure, hardware, and components as illustrated for wireless device 503 of FIG. 5. For example, wireless device 503 includes controller/processor 1480, which operates to execute logic or computer instructions stored in memory 1482, as well as controlling the components of wireless device 503 that provide the features and functionality of wireless device 503. Wireless device 503, under control of controller/processor 1480, transmits and receives signals via wireless radios 1401a-r and antennas 511a-r. As illustrated in the example of FIG. 14, memory 1482 stores one or more of ESL configuration logic 1402, ESL measurement logic 1403, ESL position logic 1404, ESL eTag removal logic 1405, measurement information 1406 (e.g., beacon and/or speed measurements), position information 1407, or ESL settings data 1408. The data (1402-1408) stored in the memory 1482 may include or correspond to data and/or logic to enable the operations of FIGS. 5-10.

The wireless communication device (e.g., UE or base station) may execute additional blocks (or the wireless communication device may be configured further to perform additional operations) in other implementations. For example, the wireless communication device may perform one or more operations described above, such as described with reference to FIGS. 5-13 and any of the operations described below. As another example, the wireless communication device may perform one or more aspects as presented below.

Accordingly, wireless communication devices may perform enhanced asset tracking operations to automatically track assets during stocking operations. Accordingly, the ESL system performance and user experience may be increased due to reduced stocking errors and increased stocking information accuracy.

In the implementations described herein, an ESL system or network may include an ESL cloud server, one or more ESL gateway servers or edge servers associated with the ESL cloud server, one or more ESL APs associated with each gateway or edge server, one or more ESL controllers associated with each ESL AP, one or more ESLs associated with each ESL controller, and one or more eTags associated with each ESL. In some implementations, the ESL system may include a plurality of energizers, which may be associated with multiple eTags of the plurality of the eTags.

In a first aspect, a device for wireless communication includes: at least one processor; and a memory coupled to the at least one processor, wherein the at least one processor is configured to cause the device to: receive a plurality of electronic tag (eTag) beacons at one or more wireless radios of a stocking device; generate eTag measurement information based on the measurement of the plurality of eTag beacons; and transmit the eTag measurement information to an electronic shelf label (ESL) server, wherein the eTag measurement information is indicative of whether a particular eTag has been removed from the stocking device.

In a second aspect, alone or in combination with the first aspect, the eTag beacons are associated with eTags attached to products on the stocking device, the particular eTag, or both.

In a third aspect, alone or in combination with one or more of the above aspects, the eTag beacons are associated with eTags attached to cases or cartons on the stocking device that include products.

In a fourth aspect, alone or in combination with one or more of the above aspects, the eTag includes a button configured to activate or enable beacon transmissions.

In a fifth aspect, alone or in combination with one or more of the above aspects, the eTag includes a magnetic switch configured to disable beacon transmissions, and wherein removing a magnet attached to the eTag deactivates the magnetic switch (which may enable transmissions and/or charging).

In a sixth aspect, alone or in combination with one or more of the above aspects, the measurement information includes signal strength information, signal quality information, timing information, beam angle information, or a combination thereof.

In a seventh aspect, alone or in combination with one or more of the above aspects, the measurement information includes RSSI, RSRP, RSRQ, AoA, TOA, RTT, beacon interval timing, or a combination thereof.

In an eighth aspect, alone or in combination with one or more of the above aspects, the at least one processor is further configured to cause the device to: determine whether the stocking device is stationary or at a stocking speed; and determine to measure eTag beacons responsive to a determination that the stocking device is stationary or at the stocking speed.

In a ninth aspect, alone or in combination with one or more of the above aspects, the at least one processor is further configured to cause the device to: determine whether the stocking device is stationary or at a stocking speed; and determine to report the eTag measurement information responsive to a determination that the stocking device is stationary or at the stocking speed.

In a tenth aspect, alone or in combination with one or more of the above aspects, the at least one processor is further configured to cause the device to: determine whether the stocking device is stationary or at a stocking speed; determine whether eTag has been removed from the stocking device based on the eTag measurement information and responsive to a determination that the stocking device is stationary or at the stocking speed; and determine to report the eTag measurement information responsive to a determination that an eTag has been removed from the stocking device.

In an eleventh aspect, alone or in combination with one or more of the above aspects, the at least one processor configured to cause the device to determine whether the stocking device is stationary or at a stocking speed includes to: determine a speed of the stocking device based on sensor information generated by sensors of the stocking device, ESL positioning operations, or a combination thereof; compare the speed to a speed threshold; and determine the stocking device is stationary or at the stocking speed based on the speed being less than or equal to the speed threshold.

In a twelfth aspect, alone or in combination with one or more of the above aspects, the at least one processor configured to cause the device to determine whether the eTag has been removed from the stocking device based on the eTag measurement information includes to: determine a current position for a first eTag based on the eTag measurement information; determine a prior position for the first eTag based on historical eTag measurement information; generate a position difference based on the current position and the prior position; compare the position difference to a position difference threshold; and determine the first eTag has been removed from the stocking device based on the position difference being greater than or equal to the position difference threshold.

In a thirteenth aspect, alone or in combination with one or more of the above aspects, the at least one processor configured to cause the device to determine whether the eTag has been removed from the stocking device based on the eTag measurement information includes to: determine a first measurement value for a first eTag based on the eTag measurement information; determine a second measurement value for the first eTag based on historical eTag measurement information; generate a measurement difference value based on the first measurement value and the second measurement value; compare the measurement difference value to a measurement difference threshold; and determine the first eTag has been removed from the stocking device based on the measurement difference value being greater than or equal to the measurement difference threshold.

In a fourteenth aspect, alone or in combination with one or more of the above aspects, the eTag measurement information and/or stocking device speed information are transmitted outside of an ESL system associated with the ESL server.

In a fifteenth aspect, alone or in combination with one or more of the above aspects, the eTag measurement information and/or stocking device speed information are transmitted via an ESL system associated with the ESL server.

In a sixteenth aspect, alone or in combination with one or more of the above aspects, the at least one processor configured to cause the device to transmit the eTag measurement information includes to: transmit, to an ESL AP, the eTag measurement information via Bluetooth or Wi-Fi and configured to cause the ESL AP to relay the eTag measurement information to the ESL server.

In a seventeenth aspect, alone or in combination with one or more of the above aspects, the at least one processor is further configured to cause the device to: determine a speed of the stocking device based on sensor information generated by sensors of the stocking device, ESL positioning operations, or a combination thereof; and transmit speed information to the ESL server based on the speed of the stocking device, the speed information indicative of whether the particular eTag has been removed from the stocking device. The speed information may be transmitted in the same transmission as the measurement information (or the position information and/or indication information) or in a different transmission.

In an eighteenth aspect, alone or in combination with one or more of the above aspects, the at least one processor is further configured to cause the device to: determine whether a particular eTag has been removed from the stocking device based on the eTag measurement information; and transmit eTag indication information to the ESL server responsive to a determination that the particular eTag has been removed from the stocking device, wherein the eTag indication information indicates that the particular eTag has been removed from the stocking device. The indication information may be transmitted in the same transmission as the measurement information (or the position information) or in a different transmission.

In a nineteenth aspect, alone or in combination with one or more of the above aspects, a method for wireless communication includes: receiving a plurality of electronic tag (eTag) beacons at one or more wireless radios of a stocking device; generating eTag measurement information based on measuring the plurality of eTag beacons; and transmitting the eTag measurement information to an electronic shelf label (ESL) server, wherein the eTag measurement information is indicative of whether a particular eTag has been removed from the stocking device.

In a twentieth aspect, alone or in combination with one or more of the above aspects, a device for wireless communication includes: at least one processor; and a memory coupled to the at least one processor, wherein the at least one processor is configured to cause the device to: receive a plurality of electronic tag (eTag) beacons at one or more wireless radios of a stocking device; generate eTag measurement information based on measurements of the plurality of eTag beacons; determine whether a particular eTag has been removed from the stocking device based on the eTag measurement information; and transmit eTag indication information to an electronic shelf label (ESL) server responsive to a determination that the particular eTag has been removed from the stocking device, wherein the eTag indication information indicates that the particular eTag has been removed from the stocking device.

In a twenty-first aspect, alone or in combination with one or more of the above aspects, a device for wireless communication includes: at least one processor; and a memory coupled to the at least one processor, wherein the at least one processor is configured to cause the device to: receive a plurality of electronic tag (eTag) beacons at one or more wireless radios of a stocking device; generate eTag measurement information based on measurements of the plurality of eTag beacons; determine whether a particular eTag has been removed from the stocking device based on the eTag measurement information; and transmit eTag indication information to an electronic shelf label (ESL) server, wherein the eTag indication information indicates that the particular eTag has been removed from the stocking device.

In a twenty-second aspect, alone or in combination with one or more of the above aspects, a device for wireless communication includes: at least one processor; and a memory coupled to the at least one processor, wherein the at least one processor is configured to cause the device to: receive a plurality of electronic tag (eTag) beacons at one or more wireless radios of a stocking device; generate eTag measurement information based on measurements of the plurality of eTag beacons; generate eTag position information based on the eTag measurement information; and transmit the eTag position information to an electronic shelf label (ESL) server, wherein the eTag position information is indicative of whether a particular eTag has been removed from the stocking device.

In a twenty-third aspect, alone or in combination with one or more of the above aspects, a device for wireless communication includes: at least one processor; and a memory coupled to the at least one processor, wherein the at least one processor is configured to cause the device to: receive a plurality of electronic tag (eTag) beacons at one or more wireless radios of a stocking device; generate eTag measurement information based on measurements the plurality of eTag beacons; and transmit eTag positioning information to an electronic shelf label (ESL) server based on the eTag measurement information, wherein the eTag positioning information is indicative of whether a particular eTag has been removed from the stocking device.

In a twenty-fourth aspect, alone or in combination with one or more of the above aspects, a device for wireless communication includes: at least one processor; and a memory coupled to the at least one processor, wherein the at least one processor is configured to cause the device to: receive, at an electronic shelf label (ESL) server from a stocking device, electronic tag (eTag) measurement information corresponding to measurements of a plurality of eTag beacons received by one or more wireless radios of the stocking device; determine, by the ESL server, whether a particular eTag has been removed from the stocking device based on the eTag measurement information; and update a position of the particular eTag based on the determination that the particular eTag has been removed from the stocking device.

In a twenty-fifth aspect, alone or in combination with one or more of the above aspects, the at least one processor is further configured to cause the device to trigger second eTag beacon measurements of one or more second eTag beacons from the particular eTag by one or more ESL radios of an ESL system; receive second eTag measurement information corresponding to measurements of the second eTag beacons; determine an updated position for the particular eTag based on the second eTag measurement information; and update the position of the particular eTag based on the determined updated position. In some aspects, the position of the particular eTag is only updated after the second measurement information is received from the ESL radios/controllers and is not updated based on the measurements or indication from the stocking device.

Components, the functional blocks, and the modules described herein with respect to the figures described above include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single-or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, that is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein but are to be accorded the widest scope consistent with this disclosure, the principles and the novel features disclosed herein.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device for wireless communication, comprising:
at least one processor; and
a memory coupled to the at least one processor, wherein the at least one processor is configured to cause the device to:
receive a plurality of electronic tag (eTag) beacons at one or more wireless radios of a stocking device;
generate eTag measurement information based on measuring the plurality of eTag beacons; and
transmit the eTag measurement information to an electronic shelf label (ESL) server, wherein the eTag measurement information is indicative of whether a particular eTag has been removed from the stocking device.

2. The device of claim 1, wherein the eTag beacons are associated with one or more eTags attached to products on the stocking device.

3. The device of claim 1, wherein the eTag beacons are associated with one or more eTags attached to cases or cartons on the stocking device that include products.

4. The device of claim 1, wherein the eTag beacons are associated with one or more eTags, and wherein at least one eTag of the one or more eTags includes a button configured to activate or enable beacon transmissions.

5. The device of claim 1, wherein the eTag beacons are associated with one or more eTags, wherein and wherein at least one eTag of the one or more eTags includes a magnetic switch configured to disable beacon transmissions, and wherein removing a magnet attached to the eTag deactivates the magnetic switch.

6. The device of claim 1, wherein the eTag measurement information includes signal strength information, signal quality information, timing information, beam angle information, or a combination thereof.

7. The device of claim 1, wherein the eTag measurement information includes received signal strength indicator (RSSI), reference signal received power (RSRP), reference signal received quality (RSRQ), angle-of-arrival (AoA), time-of-arrival (TOA), round-trip time (RTT), beacon interval timing, or a combination thereof.

8. The device of claim 1, wherein the at least one processor is further configured to cause the device to:
determine whether the stocking device is stationary or at a stocking speed; and
determine to measure eTag beacons responsive to a determination that the stocking device is stationary or at the stocking speed.

9. The device of claim 1, wherein the at least one processor is further configured to cause the device to:
determine whether the stocking device is stationary or at a stocking speed; and
determine to report the eTag measurement information responsive to a determination that the stocking device is stationary or at the stocking speed.

10. The device of claim 1, wherein the at least one processor is further configured to cause the device to:
determine whether the stocking device is stationary or at a stocking speed;
determine whether eTag has been removed from the stocking device based on the eTag measurement information and responsive to a determination that the stocking device is stationary or at the stocking speed; and
determine to report the eTag measurement information responsive to a determination that an eTag has been removed from the stocking device.

11. The device of claim 10, wherein the at least one processor configured to cause the device to determining whether the stocking device is stationary or at the stocking speed includes to:
determine a speed of the stocking device based on sensor information generated by sensors of the stocking device, ESL positioning operations, or a combination thereof;
compare the speed to a speed threshold; and
determine the stocking device is stationary or at the stocking speed based on the speed being less than or equal to the speed threshold.

12. The device of claim 10, wherein the at least one processor configured to cause the device to determining whether the eTag has been removed from the stocking device based on the eTag measurement information includes to:
determine a current position for a first eTag based on the eTag measurement information;
determine a prior position for the first eTag based on historical eTag measurement information;
generate a position difference based on the current position and the prior position;
compare the position difference to a position difference threshold; and
determine the first eTag has been removed from the stocking device based on the position difference being greater than or equal to the position difference threshold.

13. The device of claim 10, wherein the at least one processor configured to cause the device to determine whether the eTag has been removed from the stocking device based on the eTag measurement information includes to:
determine a first measurement value for a first eTag based on the eTag measurement information;
determine a second measurement value for the first eTag based on historical eTag measurement information;
generate a measurement difference value based on the first measurement value and the second measurement value;
compare the measurement difference value to a measurement difference threshold; and
determine the first eTag has been removed from the stocking device based on the measurement difference value being greater than or equal to the measurement difference threshold.

14. The device of claim 1, wherein the eTag measurement information is transmitted outside of an ESL system associated with the ESL server.

15. The device of claim 1, wherein the eTag measurement information is transmitted via an ESL system associated with the ESL server.

16. The device of claim 1, wherein the at least one processor configured to cause the device to transmit the eTag measurement information includes to:
transmit, to an ESL AP, the eTag measurement information via Bluetooth or Wi-Fi and configured to cause the ESL AP to relay the eTag measurement information to the ESL server.

17. The device of claim 1, wherein the at least one processor is further configured to cause the device to:
determine a speed of the stocking device based on sensor information generated by sensors of the stocking device, ESL positioning operations, or a combination thereof; and
transmit speed information to the ESL server based on the speed of the stocking device, the speed information indicative of whether the particular eTag has been removed from the stocking device.

18. The device of claim 1, wherein the at least one processor is further configured to cause the device to:
determine whether a particular eTag has been removed from the stocking device based on the eTag measurement information; and
transmit eTag indication information to the ESL server responsive to a determination that the particular eTag has been removed from the stocking device, wherein the eTag indication information indicates that the particular eTag has been removed from the stocking device.

19. A method for wireless communication, comprising:
receiving a plurality of electronic tag (eTag) beacons at one or more wireless radios of a stocking device;
generating eTag measurement information based on measuring the plurality of eTag beacons; and
transmitting the eTag measurement information to an electronic shelf label (ESL) server, wherein the eTag measurement information is indicative of whether a particular eTag has been removed from the stocking device.

20. A device for wireless communication, comprising:
at least one processor; and
a memory coupled to the at least one processor, wherein the at least one processor is configured to cause the device to:
receive a plurality of electronic tag (eTag) beacons at one or more wireless radios of a stocking device;
generate eTag measurement information based on measuring the plurality of eTag beacons;
determine whether a particular eTag has been removed from the stocking device based on the eTag measurement information; and
transmit eTag indication information to an electronic shelf label (ESL) server responsive to a determination that the particular eTag has been removed from the stocking device, wherein the eTag indication information indicates that the particular eTag has been removed from the stocking device.
